(19) United States
(12) Patent Application Publication
(10) Pub. No.: US 2013/0215347 A1
(43) Pub. Date: Aug. 22, 2013

(54) DISPLAY SYSTEM, MOBILE TERMINAL, AND ELECTRONIC EQUIPMENT

(71) Applicants: Daisuke Tsukio, Osaka-shi (JP); Eiji Satoh, Osaka-shi (JP)

(72) Inventors: Daisuke Tsukio, Osaka-shi (JP); Eiji Satoh, Osaka-shi (JP)

(73) Assignee: SHARP KABUSHIKI KAISHA, Osaka-shi, Osaka (JP)

(21) Appl. No.: 13/882,839

(22) PCT Filed: Oct. 28, 2011
(86) PCT No.: PCT/JP2011/074995

§ 371 Date: May 1, 2013

(30) Foreign Application Priority Data
Nov. 4, 2010 (JP) 2010-247421

(51) Int. Cl. G02F 1/1335

(52) U.S. Cl. CPC G02F 1/133553
USPC 349/42; 349/63

(57) ABSTRACT

A display system comprises a reflection-type display device comprising a display panel and a reflecting part. The display panel does not comprise a coloring layer. The display panel selectively forms a light-transmitting region and a light-scattering region. The reflecting part is provided at a back surface side of the display panel. The display system also comprises a light source device projecting a monochrome light or a multicolor light to the display panel from a front surface side of the display panel.

### TECHNICAL FIELD

The present invention relates to a display system, a mobile terminal, and an electronic equipment, which comprise a display device that can perform displaying operations with a light-transmitting region and a light-scattering region.

### BACKGROUND ART

Various kinds of projectors have been developed in recent years. Patent Document 1 discloses a projector system that uses a PDLC (Polymer Dispersed Liquid Crystal) in its screen for projecting an image.

Patent Document 1 discloses a projector system comprising a projector and a screen. The projector projects an image light. The image light is projected onto the screen. Polymer Dispersed Liquid Crystal is used in the screen of the projector system disclosed in Patent Document 1.

FIG. 31 shows a cross-sectional view of a configuration of a screen of the projector system disclosed in Patent Document 1.

As shown in FIG. 31, the screen 140 is configured so that a pair of translucent substrates 141 and 144 sandwiches a polymer dispersed liquid crystal layer 147. The pair of translucent substrates 141 and 144 is made of plastic film. Liquid crystal molecules and polymer molecules are dispersed in the liquid crystal layer 147 in a phase-separated state.

Image light is projected onto this screen 140. Depending on how bright the image is, the orientation of liquid crystals in the surface of the liquid crystal layer 147 is controlled. As a result, the amount of scattering by the liquid crystal layer 147 is controlled. Consequently, it is possible to directly adjust the amount of image light and reflected light with the screen 140.

### CITATION LIST

### Patent Documents

[Patent Document 1]

### Japanese Patent Application Publication No. 2005-114763 (Publication Date: Apr. 28, 2005)

[Patent Document 2]
Japanese Patent Application Publication No. H5-191726 (Publication Date: Jul. 30, 1993)

[Patent Document 3]
Japanese Patent Application Publication No. H11-2118844 (Publication Date: Aug. 10, 1999)

[Patent Document 4]
Japanese Unexamined Patent Application Publication (Translation of PCT Application) No. 2004-522211 (Publication Date: Jul. 22, 2004)

### SUMMARY OF INVENTION

### Technical Problem

However, according to the configuration disclosed in Patent Document 1, the degree of scattering is controlled at once for the entire surface of the screen 140. In this way, a display is presented in the most suitable manner in bright environments and in dark environments. Therefore, even if an image is projected onto the screen 140 disclosed in Patent Document 1, the two-dimensional image cannot be presented so that a viewer will see it three-dimensionally as if a picture or a letter is looming inside a mirror.

Furthermore, as shown in FIG. 32, a display panel 200 may be used as a screen to display a color image. The display panel 200 comprises a color filter (CF) 201 inside the PDLC or PNLC. In this case, the configuration disclosed in Patent Document 1 is problematic in that the reflected light becomes dark especially in the transparent part (non-display region) due to the color filter 201.

In addition, when an exposure is performed on the PDLC from the color filter side, an extremely strong light must be used in the exposure process.

The transmittance of visible light is reduced and becomes a half to one-third of the original transmittance as a result of the color filter. Therefore, it is impossible to obtain the amount of reflected light sufficient enough for the display panel 200 to act as a mirror. Furthermore, the transmittance of ultraviolet light necessary for the polymerization of PDLC and PNLC becomes less than one-fifth of the original transmittance. Consequently, it becomes necessary to use an exposure device that can achieve a strong level of illuminance.

The present invention is made to solve the problems described above. An objective of the present invention is to provide a display system, a portable terminal, and an electronic device that can bring about a display as if an image is materialized inside a mirror.

### Solution to Problem

In order to solve the problems described above, a display system according to an aspect of the present invention comprises a reflection-type display device. The display system comprises a display device comprising a display panel and a reflecting part. The display panel does not comprise a coloring layer. In addition, the display panel selectively forms a light-transmitting region and a light-scattering region. The reflecting part is provided at a back surface side of the display panel. The display system also comprises a light source device projecting a monochrome light or a multicolor light to the display panel from a front surface side of the display panel.

According to the configuration described above, the display panel does not comprise a coloring layer. Thus, no light is absorbed by any coloring layer. Therefore, a projected image can be displayed vividly.

Furthermore, a monochrome or multicolor light is projected by the light source device onto the display panel from the front side. This monochrome or multicolor light passes through the display panel and is reflected by the reflecting part placed at the back side of the display panel. The monochrome or multicolor light then exits the display panel from the front side. As a result, the monochrome or multicolor light (image) at a light-scattering region, selectively formed on the display panel, can present a display in a distinct manner as if the image is looming out of a mirror.

Incidentally, in order to solve the problems described above, a display system according to another aspect of the present invention comprises a reflection-type display device. The display system comprises a display device comprising a display panel and a reflecting part. The display panel does not comprise a coloring layer. The display panel selectively forms a light-transmitting region and a light-scattering region. The reflecting part is provided at an interior portion of the display panel. The display system also comprises a light source device projecting a monochrome light or a multicolor light to the display panel from a front surface side of the display panel.

According to the configuration described above, the display panel does not comprise a coloring layer. Thus, no light is absorbed by any coloring layer. Therefore, a projected image can be displayed vividly.

Furthermore, a monochrome or multicolor light is projected by the light source device onto the display panel from the front side. This monochrome or multicolor light passes through the display panel and is reflected by the reflecting part placed inside the display panel. The monochrome or multicolor light then exits the display panel from the front side. As a result, the monochrome or multicolor light (image) at a light-scattering region, selectively formed on the display panel, can present a display in an incomparable manner as if the image is looming out of a mirror.

Moreover, the monochrome or multicolor light is projected by the light source device onto the display panel from the front side. This monochrome or multicolor light is reflected by the reflecting part placed inside the display panel. The monochrome or multicolor light then exits the display panel from the front side. As a result, the reflectance can be enhanced compared to the case in which the reflecting part is placed at the back side of the display panel. Hence, the monochrome or multicolor light (image) can present a display in a distinct manner as if the image is looming out of a mirror.

### Advantageous Effects

A display system according to an aspect of the present invention comprises a reflection-type display device. The display system comprises a display device comprising a display panel and a reflecting part. The display panel does not comprise a coloring layer. In addition, the display panel selectively forms a light-transmitting region and a light-scattering region. The reflecting part is provided at a back surface side of the display panel. The display system also comprises a light source device projecting a monochrome light or a multicolor light to the display panel from a front surface side of the display panel.

A display system according to another aspect of the present invention comprises a reflection-type display device. The display system comprises a display device comprising a display panel and a reflecting part. The display panel does not comprise a coloring layer. The display panel selectively forms a light-transmitting region and a light-scattering region. The reflecting part is provided at an interior portion of the display panel. The display system also comprises a light source device projecting a monochrome light or a multicolor light to the display panel from a front surface side of the display panel.

As a result, the monochrome or multicolor light (image) at a light-scattering region, selectively formed on the display panel, can present a display in a characteristic way as if an image is materialized inside a mirror.

### BRIEF DESCRIPTION OF DRAWINGS

FIG. 1 is a broken-down perspective view showing an overall configuration of a display system according to the present invention. In FIG. 1, a display panel is shown in a skeletal manner by breaking down the display panel into its components.

FIG. 2 is a planar view showing an overall configuration of a key component of an active matrix substrate of a display panel of a display system according to the present invention.

FIG. 3 is a skeletal cross-sectional view showing an example of an overall configuration of a display panel of a display system according to the present invention. The cross-sectional view in FIG. 3 is obtained by cutting along line A-A shown in FIG. 2.

FIG. 4 is a planar view showing an enlarged reflection surface of a reflecting part configured so that a recursive reflection is conducted.

FIG. 5 is a skeletal cross-sectional view showing another example of an overall configuration of a display panel of a display system according to the present invention. The cross-sectional view in FIG. 5 is obtained by cutting along line A-A shown in FIG. 2.

FIG. 6 is a diagram showing an example of an image displayed on a PNLC panel.

FIG. 7 is a diagram showing an example of an image displayed when a scattering part is formed within a transparent part of a PNLC panel.

FIG. 8 is a block diagram showing an example of an overall configuration of a display system according to the present invention.

FIG. 9 is a diagram showing a configuration of a circuit of an image control part when a projector is used as a light source device.

FIG. 10 is a diagram showing a configuration of one frame.

FIG. 11 is a diagram showing a pattern for manually matching a position of an image of a display panel with a position of an image of a projector.

FIG. 12 is a block diagram showing an example of an overall configuration of a display system when a position of an image of a display panel is automatically matched with a position of an image of a projector.

FIG. 13 is a perspective diagram showing another example of an overall configuration of a display system when a position of an image of a display panel is automatically matched with a position of an image of a projector.

FIG. 14 is a perspective diagram showing yet another example of an overall configuration of a display system when a position of an image of a display panel is automatically matched with a position of an image of a projector.

FIG. 15 is a perspective diagram showing yet another example of an overall configuration of a display system when a position of an image of a display panel is automatically matched with a position of an image of a projector.

FIG. 16 is a block diagram showing another example of an overall configuration of a display system according to the present invention.

FIG. 17(a) is a graph showing a correlation between a transmittance and an angle of incidence of light when a refractive index of a display panel of a display system according to the present invention at a light-incident side equals one, and a relative refractive index of a surface of the display panel equals 1.45.

FIG. 17(b) is a graph showing a correlation between a transmittance and an angle of incidence of light when a refractive index of a display panel of a display system according to the present invention at a light-incident side equals one, and a relative refractive index of a surface of the display panel equals 1.65.

FIG. 18 is a cross-sectional view showing a direction in which liquid crystal droplets of a PDLC layer are oriented in a normal mode.

FIG. 19 is a cross-sectional view showing a direction in which liquid crystal droplets of a PDLC layer are oriented in a reverse mode.

FIG. 20(a) and FIG. 20(b) are both frontal views showing an overall configuration of a portable telephone using a display system according to an embodiment of the present invention.

FIG. 21 is a perspective view showing an overall configuration of a portable telephone shown in FIG. 20.

FIG. 22 is a cross sectional view showing an overall configuration of a portable telephone shown in FIG. 20(a), FIG. 20(b), and FIG. 21.

FIG. 23 is a planar view showing a configuration of a reflecting part of a display system according to a second embodiment.

FIG. 24 is a diagram illustrating how a reflection is performed on a reflecting part of a display system according to a second embodiment.

FIG. 25 is a perspective view showing an overall configuration of an electronic dictionary using a display system according to the present invention.

FIG. 26 is a skeletal diagram showing an overall configuration of a display system using a plurality of light source devices.

FIG. 27 is a broken-down perspective view showing an overall configuration of a display system according to a fourth embodiment. In FIG. 27, a display panel is shown in a skeletal manner by breaking down the display panel into its components.

FIG. 28 is a block diagram showing an example of an overall configuration of a display system according to a fourth embodiment.

FIG. 29 is a planar view showing an overall configuration of a key component of an active matrix substrate of a display panel of a display system according to a fifth embodiment.

FIG. 30 is a skeletal cross-sectional view showing an example of an overall configuration of a display panel of a display system according to a fifth embodiment. The cross-sectional view in FIG. 30 is obtained by cutting along line B-B shown in FIG. 29.

FIG. 31 is a cross-sectional view showing a configuration of a screen of a conventional projector system.

FIG. 32 is a cross-sectional view showing a configuration of a screen of a projector. A color filter is placed inside a display panel of the screen shown in FIG. 32.

### DESCRIPTION OF EMBODIMENTS

### First Embodiment

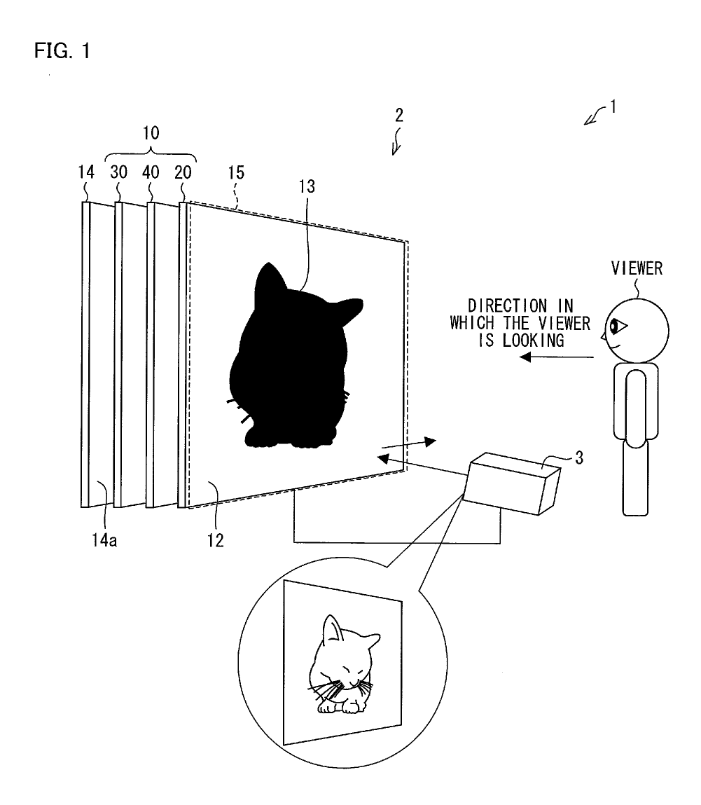

A first embodiment of the present invention is described with reference to FIG. 1 through FIG. 19.

### (Configuration of Display System 1)

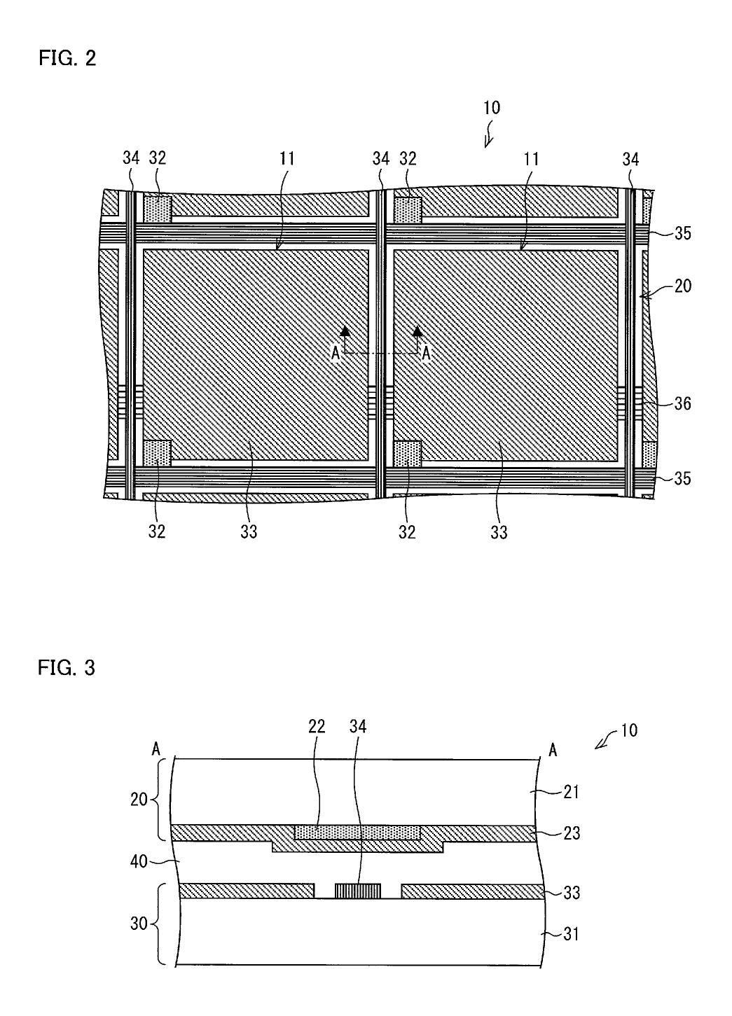

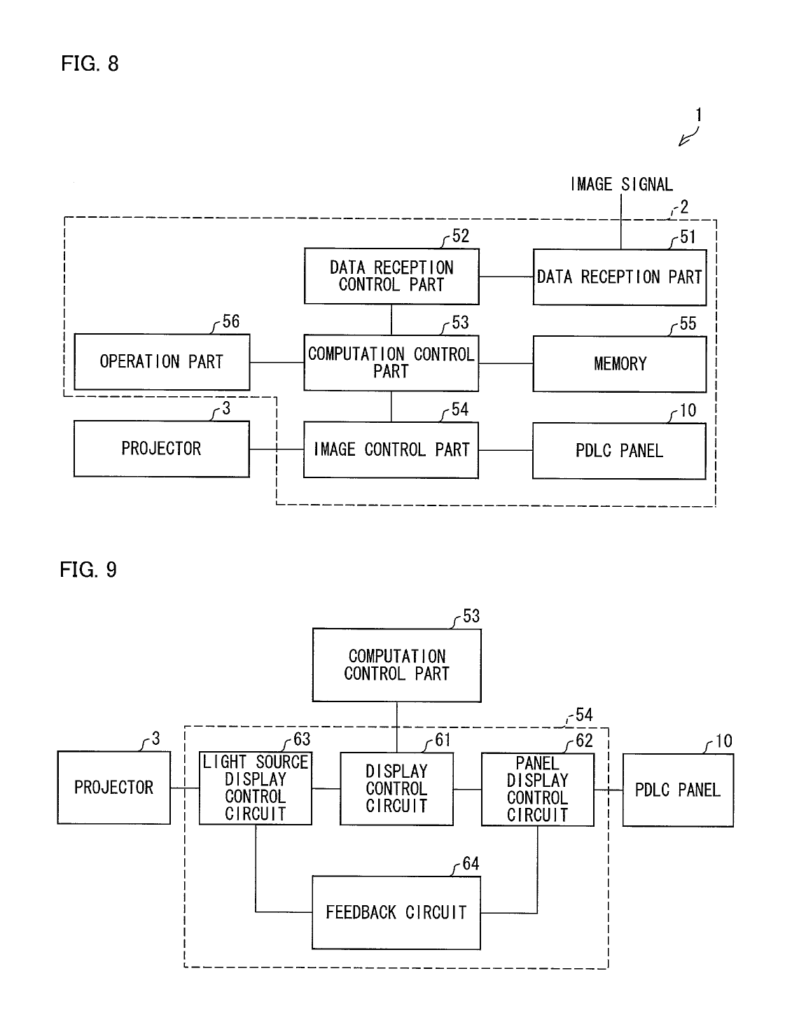

FIG. 1 is a broken-down perspective view showing an overall configuration of a display system according to the present embodiment. In FIG. 1, a display panel is shown in a skeletal manner by breaking down the display panel into its components. FIG. 2 is a planar view showing an overall configuration of a key component of an active matrix substrate of a display panel of a display system according to the present embodiment. FIG. 3 is a skeletal cross-sectional view showing an example of an overall configuration of a display panel of a display system according to the present embodiment. The cross-sectional view in FIG. 3 is obtained by cutting along line A-A shown in FIG. 2. FIG. 8 is a block diagram showing an example of an overall configuration of a display system according to the present embodiment.

Incidentally, the present embodiment is described principally based on an example in which a display system according to the present embodiment comprises a projector as a light source device (projecting device). However, the present embodiment is not restricted to this example. Various light source devices that project (radiate) monochrome or multicolor light may be used as the light source device. The light need not be an image (graphical material). In the following description, the term “projector” is used interchangeably with “light source device.”

As shown in FIG. 1, FIG. 8, and the like, a display system 1 (liquid crystal display system) according to the present embodiment comprises a display device 2 and a projector 3. The display device 2 comprises a PNLC panel 10 (display part, display panel) and a reflecting part 14. The PNLC panel 10 may assume a light-scattering state and a light-transmitting state. The reflecting part 14 is placed at an opposite side of a viewer looking at the PNLC panel 10 (placed at a back side of the PNLC panel). The projector 3 acts as a light source device that radiates light to the PNLC panel 10.

First, an overall configuration of the display device 2 is described.

As shown in FIG. 1, the display device 2 is a reflection-type display device configured so that the display device 2 comprises a PNLC panel 10 and a reflecting part 14 placed at a back side of the PNLC panel 10 (placed at a side opposite to a side at which a viewer is positioned).

In addition to the PNLC panel 10 and the reflecting part 14 acting as a display panel, the display device 2 comprises a control part as shown in FIG. 8, for instance. The control part controls a display on the PNLC panel 10 and a timing of that display. Examples of the control part include a data reception part 51, a data reception control part 52, a computation control part 53, an image control part 54, a memory 55, and an operation part 56, etc. These components other than the PNLC panel 10 and the reflecting part 14 are described later in detail.

When the PNLC panel 10 is used with a projector 3 that acts as a light source device displaying an image (graphic material), the PNLC panel 10 is used as a screen that displays an image (colored graphic material) projected from the projector 3.

The PNLC panel 10 is a liquid crystal panel configured so that a PNLC (Polymer Network Liquid Crystal) layer 40 is sandwiched between a front surface substrate and a back surface substrate. The front surface substrate is placed at the side where the viewer is. The back surface substrate is placed at the side opposite to where the viewer is. The PNLC layer 40 acts as a display medium layer (light-scattering layer, liquid crystal layer, light-modulating layer).

PNLC is structured so that liquid crystal is dispersed as droplets throughout a polymer. PNLC has the property that a light-transmitting state can be switched to a light-scattering state, and vice-versa, depending on whether an electric field is applied or not. When the PNLC panel 10 is in a normal mode, the PNLC scatters light when an electric field is not applied. Similarly, when the PNLC panel 10 is in a normal mode, the PNLC transmits light and becomes transparent when an electric field is applied. Meanwhile, when the PNLC panel 10 is in a reverse mode, the PNLC transmits light when an electric field is not applied. Similarly, when the PNLC panel is in a reverse mode, the PNLC scatters light and becomes opaque when an electric field is applied. The normal and reverse modes are described later in detail.

In this way, a light-transmitting state of the PNLC panel 10 can be switched to a light-scattering state of the PNLC panel 10, and vice-versa, depending on the magnitude of the electric field applied to the PNLC. In particular, the transition from the light-transmitting state to the light-scattering state, and vice-versa, is made depending on whether or not an electric field is applied to the PNLC.

According to the present embodiment, a partial light-scattering condition is realized by performing an active-matrix-type driving of the PNLC panel 10.

In other words, the PNLC panel 10 according to the present embodiment is an active-matrix-type liquid crystal panel. As shown in FIG. 2, the PNLC panel 10 is configured so that a plurality of pixels 11 are arranged in a matrix form. At the same time, the PNLC panel 10 comprises a TFT (Thin Film Transistor) 32, for example, as a switching element for each pixel 11. This TFT 32 controls the application of electric field to each pixel 11 (whether an electric field is applied or not, for instance).

As shown in FIG. 1 and FIG. 2, the PNLC panel 10 according to the present embodiment is configured so that the PNLC layer 40 is sandwiched between a substrate 30 (active matrix substrate) and a substrate 20 (opposing substrate). A multitude of pixels 11 (see FIG. 2) are arranged on the substrate 30 in a matrix form. The substrate 20 is placed at a position opposite to the substrate 30. The PNLC layer 40 acts as a display medium layer (light-scattering layer, liquid crystal layer) which can assume a light-scattering state and a light-transmitting state.

Incidentally, the present embodiment introduces the PNLC panel 10 as an example of a liquid crystal panel. The PNLC panel 10 is configured so that a PNLC layer is sandwiched as a display medium layer. However, the liquid crystal panel may be configured so that a PDLC (Polymer Dispersed Liquid Crystal) is sandwiched instead of the PNLC.

Further, in the example given in the following description, the opposing substrate 20 is the front surface substrate and the active matrix substrate 30 is the back surface substrate, as shown in FIG. 1. However, the present embodiment is not restricted to this configuration.

Moreover, in the present embodiment, the TFT substrate is given as an example of the substrate 30. The TFT substrate comprises a switching element comprising a TFT. However, the present embodiment is not restricted to this configuration.

As shown in FIG. 2, the substrate 30 comprises a transparent substrate 31 such as a glass substrate, etc., as an insulating substrate.

As shown in FIG. 2 and FIG. 3, a plurality of TFT 32 and pixel electrodes 33 are provided on the transparent substrate 31. In addition, a plurality of wirings such as a source wiring 34, a gate wiring 35, a Cs wiring 36 (capacity supplementing wiring), and the like, are provided on the transparent substrate 31.

Incidentally, the configuration of the TFT 32 is the same as a conventional configuration. Further, gate insulating films and inter-layer insulating films, etc., are well known. Therefore, details of the TFT 32, the gate insulating film, the inter-layer insulating film, and the like, are not drawn in the Figures.

The pixel electrode 33 is a transparent electrode. The pixel electrode 33 is formed with conductive material that possesses transparency. ITO (indium tin oxide) is an example of such a conductive material. As shown in FIG. 2, each pixel electrode 33 is separated from one another. The pixel electrode 33 defines the pixel 11, which acts as one unit of the image being displayed.

The source electrode (not diagrammed), the gate electrode (not diagrammed), and the drain electrode (not diagrammed) of the TFT 32 are respectively connected to the source wiring 34, the gate wiring 35, and the pixel wiring 33. The source wiring 34 is connected to the pixel electrode 33 via the TFT 32. Further, the gate wiring 35 selectively operates the TFT 32. The Cs wiring 36 is placed opposite to the pixel electrode 33 so that a supplemental capacity is formed at the portion overlapping with the pixel electrode 33.

As shown in FIG. 2, the source wiring 34 and the gate wiring 35 cross one other, seen from the normal direction of the substrate 20 (see FIG. 1). The source wiring 34 and the gate wiring 35 are respectively connected to a source driver and a gate driver of a drive circuit placed on the substrate 30. This drive circuit is not diagrammed.

The source wiring 34, the gate wiring 35, and the Cs wiring 36 are generally manufactured using a metallic material that blocks light. Examples of such metallic material include tantalum.

As shown in FIG. 3, the substrate 20 comprises a transparent substrate 21 such as a glass substrate as the insulating substrate.

A black matrix 22 (a light-shielding film) and an opposing electrode 23 are provided on the transparent substrate 21. The opposing electrode 23 comprises a transparent conductive film such as ITO. If necessary, the black matrix 22 is placed between adjacent pixels 11, 11 and at a margin of the display region so that the TFT 32 and wirings such as the source wiring 34, the gate wiring 35, and the Cs wiring 36 are shielded from light.

The PNLC panel 10 is configured so that the state of the PNLC layer 40 can be switched between a light-transmitting state and a light-scattering state by controlling the electric field applied to the PNLC layer 40, i.e., the electric voltage applied between the opposing electrode 23 and the pixel electrode 33.

The PNLC panel 10 does not comprise a CF (color filter, coloring layer). The TFT 32 controls whether or not an electric field is applied to the PDLC. As a result, a transparent part 12 and a scattering part 13 are selectively formed as shown in FIG. 1. The transparent part 12 is a light-transmitting region. The scattering part 13 is a light-scattering region.

The reflecting part 14 is placed at a back side of the PNLC panel 10 (at the opposite side of where the viewer is). The reflecting part 14 reflects light that passed through the light-transmitting region of the PNLC panel 10.

The reflecting part 14 comprises a reflection surface 14a. Light from the projector 3, acting as the light source device, is reflected at the reflection surface 14a. The reflection surface 14a of the reflecting part 14 faces the back surface of the substrate 30.

The reflection surface 14a of the reflecting part 14 is a flat mirror surface. As a result, light can be reflected at the reflection surface 14a at a high reflectance. Further, the PNLC panel 10 does not comprise a CF and has a high transmittance. By configuring the reflection surface 14a of the reflecting part 14 as a flat mirror surface, the PNLC panel 10 and the reflecting part 14 placed at the back side of the PNLC panel 10 can be used as a mirror.

The reflecting part 14 is configured so that light passing through the PNLC panel 10 reflects at the reflection surface 14a and exits the PNLC panel 10 from the front side.

The reflection surface 14a of the reflecting part 14 is made of material having a high reflectance. For example, the reflection surface 14a is made of a material having Al (aluminum) and Ag (silver), etc., as the main constituents.

In this way, the reflection surface 14a of the reflecting part 14 is a mirror surface. Therefore, the display device 2 can be used as a mirror.

Further, the reflecting part 14 can be configured so that a recursive reflection plate acts as the reflection surface. Here, the recursive reflection plate is used instead of the reflection surface 14a, i.e., the flat mirror surface.

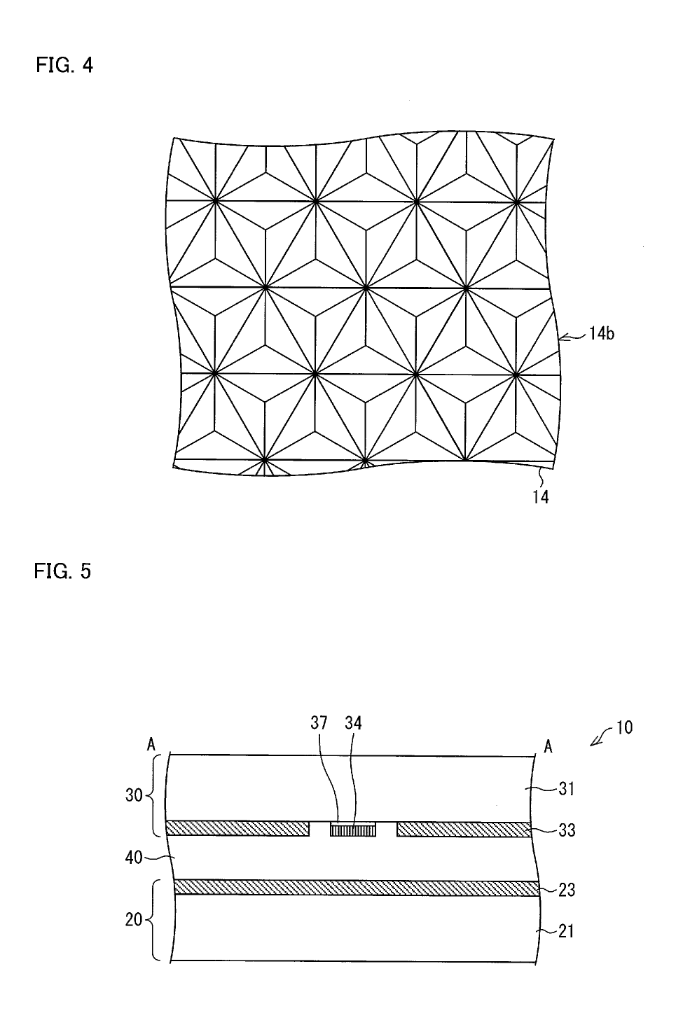

FIG. 4 is a planar view showing an enlarged reflection surface of a reflecting part 14 configured so that a recursive reflection is conducted.

As shown in FIG. 4, the reflection surface 14b of the reflecting part 14 is configured so that a recursive reflection is conducted. In other words, a corner cube array is aligned on the reflection surface 14b of the reflecting part 14. As a result, a recursive reflection is carried out.

The reflection surface 14b of the reflecting part 14 is configured so that the reflection surface 14b is shaped as a corner cube array that brings about a recursive reflection. This configuration provides a remedial measure to the problem that, when the direction of the regular reflection is too bright and a mirror is used, the contrast in the display provided by the projector 3 (light source device) tends to diminish.

In addition, configuring the reflecting part 14 as a corner cube array and the like that performs a recursive reflection solves the problem that, when a light source with an extremely high brightness such as sunlight is present in the direction of the regular reflection, the light reflected from the PNLC panel 10 becomes glaring.

The shape of the corner cube array shown in FIG. 4 is only an example. A corner cube array that can trigger a variety of known recursive reflections can be used for the reflection surface of the reflective part 14.

According to the display device 2 configured in these ways, the transparent part 12 and the scattering part 13 of the PNLC panel 10 can be freely and selectively created (controlled) by controlling the electric field applied to each pixel 11 of the PNLC panel 10. In other words, a scattering part 13 having the same shape as the image that is to be displayed on the PNLC panel 10 can be created on the surface of the PNLC panel 10.

In addition, the PNLC panel 10 does not comprise a color filter. As a result, light (image) is not absorbed at the transparent part 12 in particular. Consequently, a high reflectance is exhibited.

In this way, an image is not projected onto the transparent part 12 of the PNLC panel 10. An image is projected to the scattering part 13 from the projector 3. As a result, the displayed image, such as a drawing or a letter, is shown as if it is materializing in midair inside a mirror.

Here, a direct reflection from a wiring disrupts the appearance of the displayed image shown as if it is looming out in midair.

As a result, the PNLC panel 10 is configured so that the black matrix 22 (a light-shielding film), covering the wirings as descried above, or the PNLC layer 40, which is a light-scattering layer, is placed in the front side of the wirings with respect to the viewer. This configuration is shown in FIG. 1 and FIG. 3.

Therefore, it is possible to block exterior light being reflected directly at the wirings in the primary direction in which the viewer is looking. In other words, exterior light enters the transparent part 12 of the PNLC panel 10. A direct reflection of this light at the wirings inside the PNLC panel 10 at the transparent part 12 can be avoided. As a result, this configuration can prevent the distinct appearance of an image, displayed as if it is looming out of a mirror, from being marred.

Incidentally, there is no restriction on how thick the light-shielding film should be. The thickness may be, for example, roughly 0.2 μm when chrome is used, or roughly 1 to 2 μm when black resist is used.

It is preferable that the thickness of the PNLC layer 40 be, for example, within the range of 3 μm to 20 μm in order to obtain a transmittance (0.1% to 30%) of the light-scattering state described later. It is even more preferable that the thickness of the PNLC layer 40 be within the range of 3 μm to 15 μm in order to obtain a transmittance (40% to 90%) of the light-transmitting state and a transmittance (0.1% to 30%) of the light-scattering state described later.

Incidentally, in the configuration described above, a light-shielding film comprising a black matrix 22 is placed between the transparent substrate 21 and the opposing electrode 23. At the same time, a substrate 20, mounted with the black matrix 22, is used as the front surface substrate. As a result, seen from a viewer, the black matrix 22/the PNLC layer 40 (light-scattering layer)/wirings such as the source wiring 34, the gate wiring 35, and the Cs wiring 36/are provided in this order in this example. However, the present embodiment is not limited to this example.

For instance, when the substrate 30, which is an opposing substrate, is used as the front surface substrate, it is possible to provide a light-shielding film such as a black matrix above the wiring of the substrate 20 (in other words, at the opposing side of the wirings with respect to the substrate 30).

When a black matrix is provided on the substrate 20 in this way, a light-shielding film can be created on the wiring by painting a black resist onto the wiring, and by exposing and developing it, for example. At this time, the film thickness of the black resist is set to 1 μm, for instance, to obtain an optical density (OD=2 to 4) that is the same as the optical density obtained when a light-shielding film is provided on the substrate 30.

FIG. 5 is a skeletal cross-sectional view showing another example of an overall configuration of a display panel according to the present embodiment. The cross-sectional view in FIG. 5 is obtained by cutting along line A-A shown in FIG. 2.

A substrate 30 is an active matrix substrate (TFT substrate). When this substrate 30 is used as the front surface substrate, a wiring reflectance reduction layer 37 (reflectance reduction layer) may be provided between the transparent substrate 31 of the substrate 30 and the wiring (in other words, at the back side of the wiring) as shown in FIG. 5. The wiring reflectance reduction layer 37 is provided to reduce the wiring reflectance from the back surface of the substrate 30 (a surface at the other side of the opposing surface of the PNLC layer 40). As described above, the substrate 30 is an active matrix substrate. Examples of the wiring reflectance reduction layer 37 include a silicon nitride film and a thin metallic film. Insulating films such as a gate insulating film or an inter-layer insulating film are not drawn in FIG. 5 as well.

Incidentally, there is no specific limitation on the thickness of the wiring reflectance reduction layer 37. It suffices to adjust the thickness so that it is possible to prevent any disruption to the distinct appearance of an image displayed as if it is floating out of a mirror in midair, according to what materials are used in the wiring reflectance reduction layer 37.

Further, a reflection prevention film 15 may be provided on at least one surface of the PNLC panel 10 as shown in FIG. 1 (in other words, a surface of at least the substrates 20 and 30 that does not face the PNLC layer 40). The reflection prevention film 15 is provided to restrain and prevent a reflection of external light at the surface of the substrate (in other words, the reflection at the surface of substrates 20 and 30).

Preferable examples of the reflection prevention 15 include an AR (Anti-Reflective) film, an LR (Low Reflection) film, and a non-reflective film. The AR film and the LR film restrain reflection by using interference. The non-reflective film has a so-called “moth's eye” structure on its surface. This “moth's eye” structure comprises a protrusion along a curve. The protrusion is called a “moth's eye.” The refractive index of this structure in the thickness direction changes continuously.

In this way, by providing a reflection prevention film 15 on the front surface of the PNLC panel 10, it is possible to restrain or prevent exterior light from reflecting at the surface of the substrate 20, in particular, at the transparent part 12. As a result, it is possible to prevent any disruption to the three-dimensional and characteristic appearance of a graphic material (image) of the scattering part 13 displayed as if it is looming out inside a mirror.

Furthermore, it is preferable that the reflection prevention film 15 is processed so that ultraviolet light does not pass through the reflection prevention film 15. Examples include processing the reflection prevention film 15 so that it exhibits properties of absorbing ultraviolet light. As a result, it is possible to prevent the quality of the PNLC panel 10 from deteriorating due to ultraviolet light such as sunlight.

Moreover, when the reflection prevention film 15 is not used, it is preferable that at least one substrate surface be processed directly so that ultraviolet light does not pass through the substrate surface. Examples include conferring ultraviolet absorption properties to a film and placing this film on the surface of the PNLC panel 10. The film has undergone a processing so that ultraviolet light does not pass through the film.

Furthermore, it is preferable that these procedures against ultraviolet light be performed on both the substrate 20 and the substrate 30.

### (Displaying Operation)

Next, a displaying operation of the display system 1 is described.

The display system 1 is configured so that the PNLC panel 10 acts as the display part (screen part). The projector 3 projects (radiates) light (an image) to the PNLC panel 10.

An electrical field is applied selectively to each pixel 11. As a result, a transparent part 12 (light-transmitting region) and a scattering part 13 (light-scattering region) are selectively formed on the PNLC panel 10.

In the following description, a normal mode is given as an example. In this normal mode, applying an electric field (ON state) leads to a light-transmitting state, whereas not applying any electric field (OFF state) leads to a light-scattering state. In a reverse mode, applying an electric field (ON state) leads to a light-scattering state, whereas not applying any electric field (OFF state) leads to a light-transmitting state. Otherwise, the reverse mode is completely the same as the normal mode.

It is preferable to configure the PNLC panel 10 so that it can be driven at 10V, for example. The objectives of this configuration include keeping the power consumption low or ensuring that a general-purpose driver can be used. In other words, it is preferable that the material, manufacturing conditions, cell thickness, and the like, of the PNLC panel 10 be set so that a TFT drive can be performed at less than or equal to 10V.

The PNLC panel does not comprise a CF. When an electric field is applied to a pixel 11, the pixel 11 becomes transparent (can be seen through) at a high transmittance (panel transmittance) devoid of any CF. Hence, when a projector 3 is placed in front of (at the front side of) the PNLC panel 10 as seen from a viewer, and the projector 3 projects an image (scattering image) onto the scattering part 13, the projected image is displayed as a glowing image.

In other words, when a projected image is the light projected onto the PNLC panel 10 by using a projector 3 as the light source device, the projector 3 outputs an image of a character, etc., that is to be shown on the PNLC panel 10, as illustrated in FIG. 1. The PNLC panel 10 then creates a scattered part 13. The shape of this scattered part 13 is the shape of a filled-out silhouette of at least a portion (such as a character) of the image (such as a character) outputted from the projector 3 that is not black. The image (such as a character) outputted from the projector 3 is the one that is to be shown on the PNLC panel 10.

Among the images sent from the projector 3, the image that is projected on the scattering part 13 is scattered by the scattering part 13. In addition, a part of the image (light) that passed through the scattering part 13 of the PNLC panel 10 is reflected by the reflection surface 14a of the reflecting part 14 placed at the back side of the PNLC panel 10. This part of the image (light) is scattered again by the scattering part 13, and exits the PNLC panel 10 from the front side.

Meanwhile, the transparent part 12 (i.e., the pixel 11 of the translucent display) is configured so that the PNLC panel 10 becomes transparent, and a viewer is able to see the reflecting part 14 placed at the back side.

Among the light sent from the projector 3, light other than the image projected on the scattering part 13 passes through the transparent part 12. The light that passed through this transparent part 12 is reflected by the reflecting part 14, and passes through the transparent part 12 again. This light then exits the PNLC panel 10 from the front side. In this way, the reflecting part 14 reflects light that passes through the PNLC panel 10.

In this way, the display system 1 is configured so that an image (monochrome or multicolor light) is projected by the projector (light source device) 3 from the front side of the PNLC panel (display panel). This image (monochrome or multicolor light) passes through the PNLC panel 10, and is reflected by the reflecting part 14 placed at the back side of the PNLC panel 10. The image (monochrome or multicolor light) then exits the PNLC panel from the front side. As a result, the light (image) at the scattering part (light-scattering region) 13, selectively formed on the PNLC panel 10, can present a display in a distinct manner as if the image is materialized inside a mirror.

Further, the display device 2 is configured so that the reflecting part, placed at the back side of the PNLC panel 10, reflects scattered light (the projected image) which has already passed through the scattering part 13. This reflected scattered light then passes through the scattering part 13 and is scattered again. Since the projected image passes through the scattering part 13 twice, a greater scattering effect can be obtained compared to the case in which the projected image passes through the scattering part 13 only once. As a result, the image (scattered image) projected to the scattering part 13 can be viewed at a higher viewing angle.

Moreover, the PNLC panel 10 does not comprise any CF. Therefore, any color projected from the projector 3 can be displayed freely on the scattering part 13. The PNLC panel itself does not display a color, as described above. Hence, the pixel 11 need not be divided into three parts based on RGB. Thus, the PNLC panel 10 can be designed with a higher aperture ratio. The PNLC panel 10 can therefore assume a transparent state having a higher transmittance.

In addition, the PNLC panel 10 does not comprise any CF. Thus, no light is absorbed by any CF. Therefore, the transparent part 12 of the PNLC panel 10, in particular, exhibits a high reflectance. Hence, a projected image can be displayed vividly.

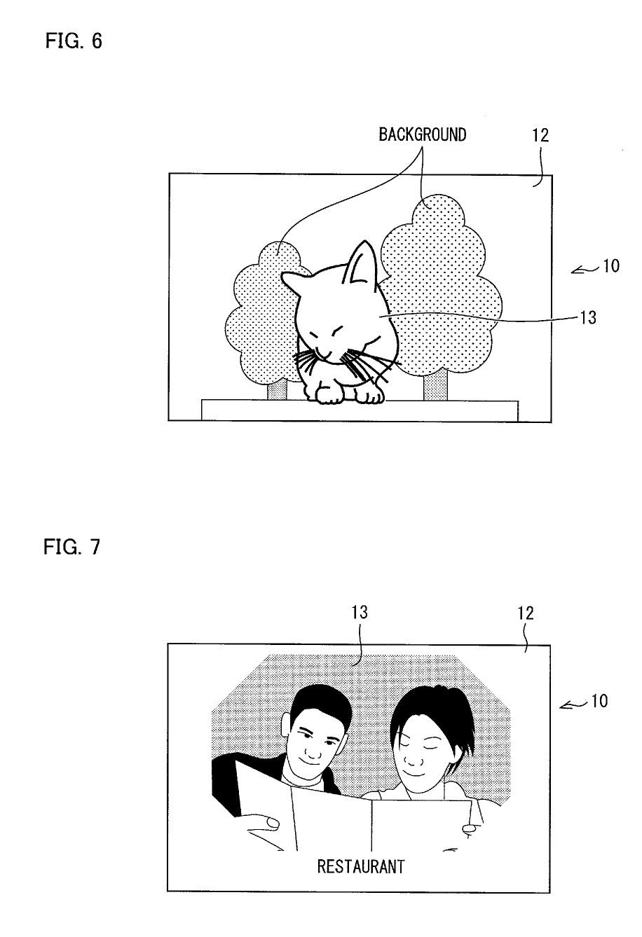

FIG. 6 is a diagram showing an example of an image displayed on the PNLC panel 10.

FIG. 6 shows an image displayed when a scattered image is combined with a reflected image. The scattered image is the projected image. The reflected image is the background. The image projected from the projector 3 is displayed on the scattered part 13. As shown in FIG. 1, the shape of this scattered part 13 is the shape created by the contour of the image projected by the projector 3. The region surrounding the scattering part 13 is displayed by a permeation through the transparent part 12 and by a reflection at the reflecting part 14.

In this way, the projected image is projected onto the scattering part 13 and is scattered. Its background image is projected onto the transparent part 12 and is reflected at the reflecting part 14 at the back surface. As a result, it is possible to present a distinct display as if the scattered image (such as a picture or a letter) is materialized inside a mirror.

Incidentally, the image projected from the projector 3 can be clipped out freely by changing the shape of the transparent part 12 and the scattering part 13, for instance. By combining with background images, various kinds of sui generis displays can be presented.

FIG. 7 is a diagram showing an example of an image displayed when a scattering part 13 is formed within a transparent part 12 of the PNLC panel 10. According to FIG. 7, scattered images and scattered letters are displayed by forming a scattering part 13 in front of the background. This scattering part 13 can be shaped freely. In this way, the contour can be clipped out into an optional shape, and the image and the letters, etc., can be scattered and displayed.

### (Image Processing)

Next, an image processing of the display system 1 is described.

As described above, when a projector 3 displaying a graphic material (image) is used as the light source device 4, the image on the PNLC panel formed by the transparent part 12 and the scattered part 13 is synchronized with the image displayed by the projector 3.

A method of synchronizing these images is described next as an image processing procedure performed by the display system 1.

First, as an introduction, the overall configuration of the display device 2 of the display system 1 is described with reference to FIG. 8.

As shown in FIG. 8, the display device 2 comprises the PNLC panel 10. In addition, the display device 2 comprises, for example, a data reception part 51, a data reception control part 52, a computation control part 53, an image control part 54, a memory 55, and an operation part 56.

The data reception part 51 receives an image signal (such as image data having a mixture of characters, letters, and the like, as well as sound data) from an outside device. This signal reception is made possible by a reception control performed by the data reception control part 52. The signal reception is made through a wired or wireless connection. When a recording medium such as a memory card is used as the outside device, for instance, the image signal can be obtained through a slot in which the recording medium is inserted. The received image signal is sent to the computation control part 53.

Based on the image signal received from the data reception control part 52, the computation control part 53 creates an image that is to be displayed on the PNLC panel 10. The image created at this time is sent to the image control part 54. In addition, the created image is sent to the memory 55 and is stored. The computation control part 53 performs a computation based on instructions inputted from the operation part 56.

The image requested by the computation control part 53 is converted by the image control part 54 into an image to be displayed on the PNLC panel 10. The image control part 54 sends this converted image to the PNLC panel 10. The image control part 54 also converts this image into an image to be outputted from the projector 3, and sends this converted image to the projector 3.

Here, the image control part 54 controls the image that is to be outputted from the projector 3. This image looks as if the contour of an image to be displayed on the PNLC panel (figures, letters, and the like) are filled out (having underwent a binary, thresholding procedure). The image control part 54 sends this created image (hereinafter may be referred to as a “binarized image”) to the PNLC panel 10.

The display system 1 comprising the display device 2 is configured so that, in order to display an image appropriately using a projector 3 and a PNLC panel 10, the image of the projector 3 is displayed in synchrony with the image of the PNLC panel 10, as described above.

In other words, when a projector that displays images is used as the projector 3, for instance, the time at which the image of the PNLC panel 10 is displayed is matched with the time at which the image of the projector 3 is displayed.

### (Control of Timing)

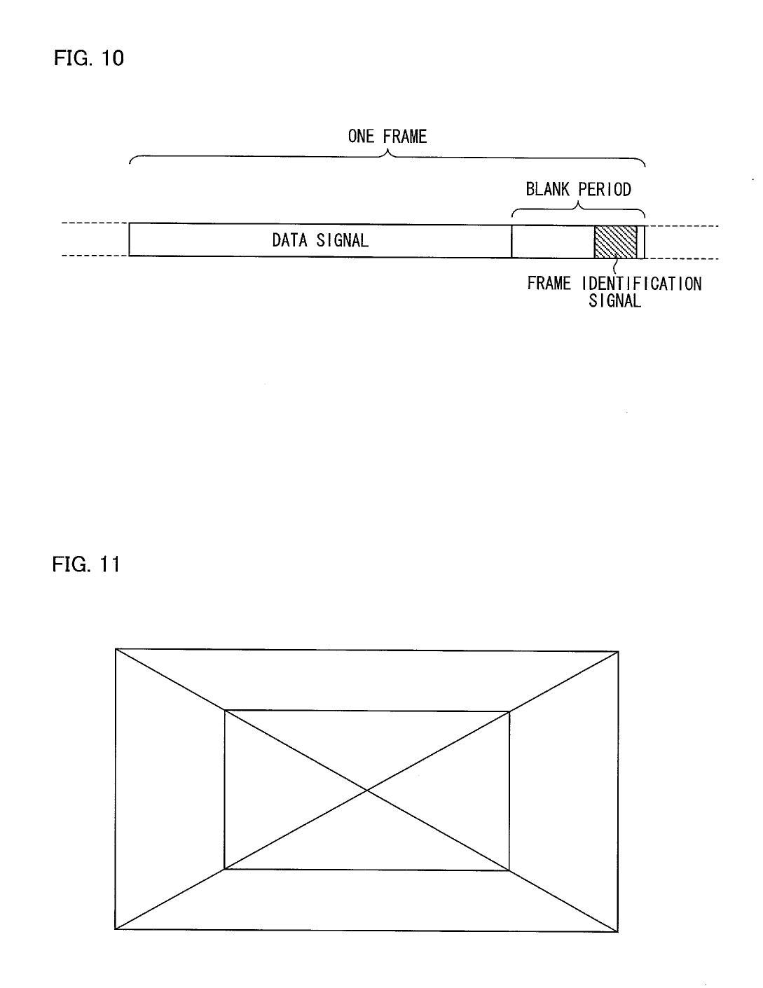

FIG. 9 shows a configuration of a circuit of the image control part 54 when the projector 3 is used as the light source device 4. FIG. 10 shows a configuration of one frame.

As shown in FIG. 9, the image control part 54 comprises a display control circuit 61, a panel display control circuit 62, a light source display control circuit 63, and a feedback circuit 64. The panel display control circuit 62 is used to display an image on the PNLC panel 10 based on the data signal sent from the display control circuit 61. The light source display control circuit 63 outputs an image to the projector 3 based on the data signal sent from the display control circuit 61. The feedback circuit 64 sends a display control signal to the panel display control circuit 62 and the light source display control circuit 63. This display control signal is used to match the time at which an image is displayed on the PNLC panel 10 using the panel display control circuit 62 and the time at which the projector 3 outputs an image using the light source display control circuit 63.

Incidentally, a sound output part (not diagrammed) is connected to the computation control part 53 and the feedback circuit 64. The sound output part outputs sound data as a sound.

From the image that the computation control part 53 requested, the display control circuit 61 generates a signal showing an image that is to be displayed on the PNLC panel 10 (i.e., a data signal showing a gradation of each pixel 11 for each frame). The display control circuit 61 then sends this generated signal to the panel display control circuit 62.

In addition, from the image that the computation control part 53 requested, the display control circuit 61 generates a signal showing an image that is to be outputted by the projector 3 (i.e., a data signal showing a gradation of each color of each pixel 11 for each frame). The display control circuit 61 then sends this generated signal to the light source display control circuit 63.

This data signal is sent to the panel display control circuit 62 and the light source display control circuit 63 with a frame identification signal that identifies a corresponding frame. The period at which the data signal is sent may be configured so that, as shown in FIG. 10, for example, the data signal is sent during a first half of one frame, and the frame identification signal is sent during a latter half of this frame. This latter half corresponds to a blank period. In this way, the data signal and the frame identification signal are sent to each circuit as data for one frame.

Among the data for one frame that was received, the panel display control circuit 62 and the light source display control circuit 63 each sends a frame identification signal to the feedback circuit 64. From among the respective frame identification signals, the feedback circuit 64 determines whether or not they are signals that identify the same frame. If the feedback circuit 64 determines that they are the same, the feedback circuit 64 sends a display control signal to the panel display control circuit 62 and the light source display control circuit 63. This display control signal is used to display an image simultaneously.

Based on the display control signal that was sent, the panel display control circuit 62 sends an already-transmitted data signal to the PNLC panel 10. Thus, the panel display control circuit 62 makes the PNLC panel 10 display an image. At the same time, based on the display control signal that was sent, the light source display control circuit 63 sends an already-transmitted data signal to the projector 3. Thus, the light source display control circuit 63 makes the projector 3 display an image.

In this way, by using the image control part 54 shown in FIG. 9, the display system 1 is configured so that the image on the PNLC panel 10 and the image from the projector 3 can be displayed in synchrony. In this case, the image outputted from the projector 3 is displayed only on the scattering part 13 of the PNLC panel 10. The transparent part 12 of the PNLC panel 10 can be configured to be transparent (a viewer can look through the transparent part 12) exhibiting a high panel transmittance without any CF.

As a result, within the PNLC panel 10, the graphic figure (image) is scattered only at the scattered part 13. The image that passed through the transparent part 12 (including images other than the image that is scattered at the scattering part 13) is reflected at the reflecting part 14 at the back surface, and is reflected towards the front side of the PNLC panel 10. As a result, drawings and letters (images) can be displayed as if they are looming out of a mirror. Such a display can be made in synchrony with sound.

The PNLC panel 10 is configured so that an image is displayed at the scattering part 13 by the light projected from the projector 3. Light is projected from the projector 3 only to the scattering part 13 formed on the PNLC panel 10, as described above. As a result, a sharp, high-definition display can be provided. The power consumption can be reduced as well.

### (Positioning)

In order to appropriately display an image on the scattering part 13 with the projector 3 as described above, the scattering part 13 of the PNLC panel 10 is overlapped with image from the projector 3.

A method of positioning the image on the PNLC panel 10 and the image from the projector 3, according to a configuration of the display system 1, is described next.

The matching of the positions can be performed manually or automatically.

### (Matching the Positions Manually)

FIG. 11 is a diagram showing a pattern for manually matching a position of an image of the PNLC panel 10 with a position of an image of the projector 3.

In this case, a pattern shown in FIG. 11 is displayed on both the PNLC panel 10 and the projector 3. The pattern includes a central point, vertical lines, horizontal lines, and diagonal lines. The pattern is displayed at a size smaller than or equal to the size of the display screen.

When the PNLC panel 10 and the projector 3 are installed, the central point, the vertical lines, the horizontal lines, and the diagonal lines of the image on the PNLC panel 10 and the image from the projector 3 are overlapped. In order to do so, the locations, the angles, the focus, and the keystone distortions of the PNLC panel 10 and the projector 3 are adjusted. In this way, the positioning process can be performed manually.

### (Matching the Positions Automatically)

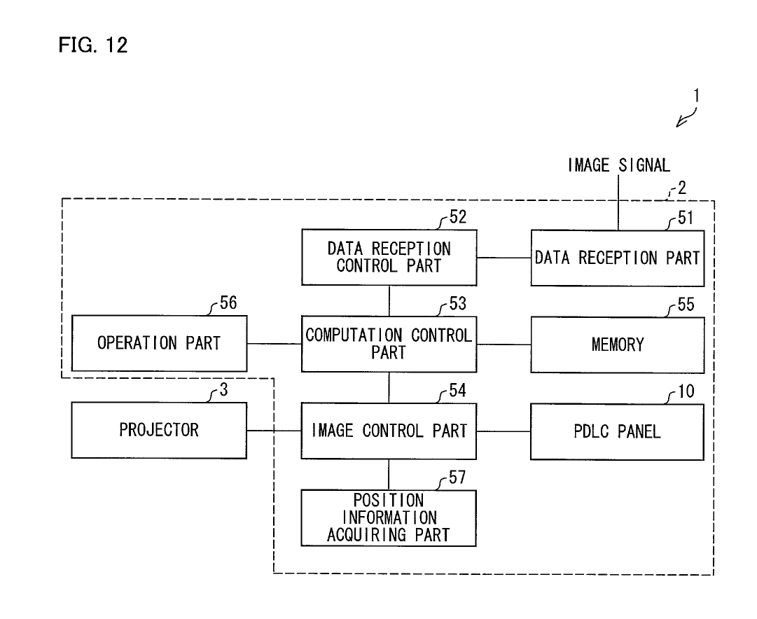

Next, a method of automatically performing a positioning process is described with reference to FIG. 12 to FIG. 15.

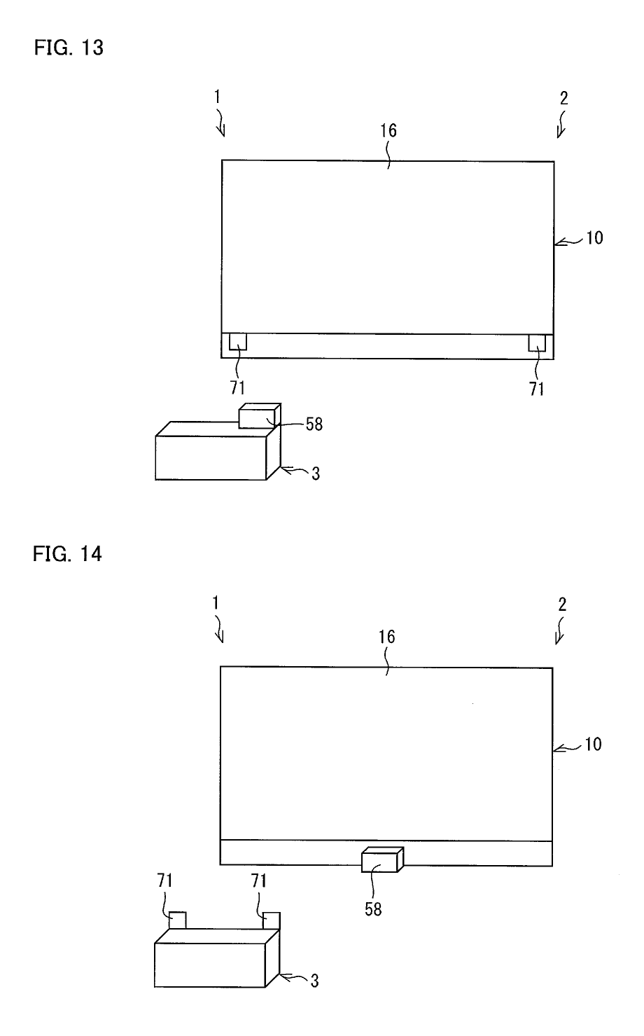

FIG. 12 is a block diagram showing an example of an overall configuration of the display system 1 when a positioning process is performed automatically. Each one of FIGS. 13 through 15 shows a perspective view of another example of an overall configuration of the display system 1 when a positioning process is performed automatically.

As described above, when the positioning process is performed automatically, a position information acquiring part 57 is provided on the display device 2, as shown in FIG. 12, for instance. The position information acquiring part 57 obtains information on the position of the PNLC panel 10 with respect to the projector 3. Alternatively, the position information acquiring part 57 obtains information on the position of the projector 3 with respect to the PNLC panel 10. In this way, the positioning process can be performed automatically.

Alternatively, as shown in FIG. 13, recursive reflection plates 71, 71 may be provided outside the display area 16 of the PNLC panel 10. Further, a sensor 58 comprising a light reception element and a light-emitting element may be provided on the projector 3. The light reflected from the recursive reflection plates 71, 71 can be received by the light reception element of the sensor 58. Thus, positioning information can be detected based on the value outputted from the sensor 58.

Incidentally, as shown in FIG. 14, recursive reflection plates 71, 71 may be provided on the projector 3. A sensor 58 comprising a light reception element and a light-emitting element may be provided outside the display area 16 of the PNLC panel 10. The light reflected from the recursive reflection plates 71, 71 can be received by the light reception element of the sensor 58. Thus, positioning information can be detected based on the value outputted from the sensor 58.

The positioning information may be detected from an output of the sensor 58 using a triangulation method. The positioning information may also be detected by using a laser light source (different from the projector 3) and by applying a phase difference ranging method.

The positioning information obtained in this way is sent to the position information acquiring part 57 shown in FIG. 12. The positioning information obtained by the position information acquiring part 57 is sent to the image control part 54.

Based on this positioning information, the image control part 54 makes the projector 3 perform various adjustments (position adjustments) in order to match the position of the image of the PNLC panel 10 and the position of the image from the projector 3.

In particular, when a keystone distortion has occurred on the image from the projector as a result of how the projector 3 is placed with respect to the PNLC panel 10, this keystone distortion is corrected. When the direction in which light is projected from the projector is imprecise, the direction in which the projection is made is corrected. When the projector 3 is out of focus, the focus is adjusted.

Such positioning procedures (position adjustments) are performed when the PNLC panel 10 and the projector 3 are installed. These procedures may also be performed temporarily when a positioning becomes necessary for some reason after the installation.

Therefore, the recursive reflection plates 71, 71 and the sensor 58 may be attached temporarily when a positioning procedure is performed. The recursive reflection plates 71, and the sensor 58 are components used to detect positioning information described above. The recursive reflection plates 71, 71 and the sensor 58 can be attached permanently as well. The positioning procedures may be performed periodically.

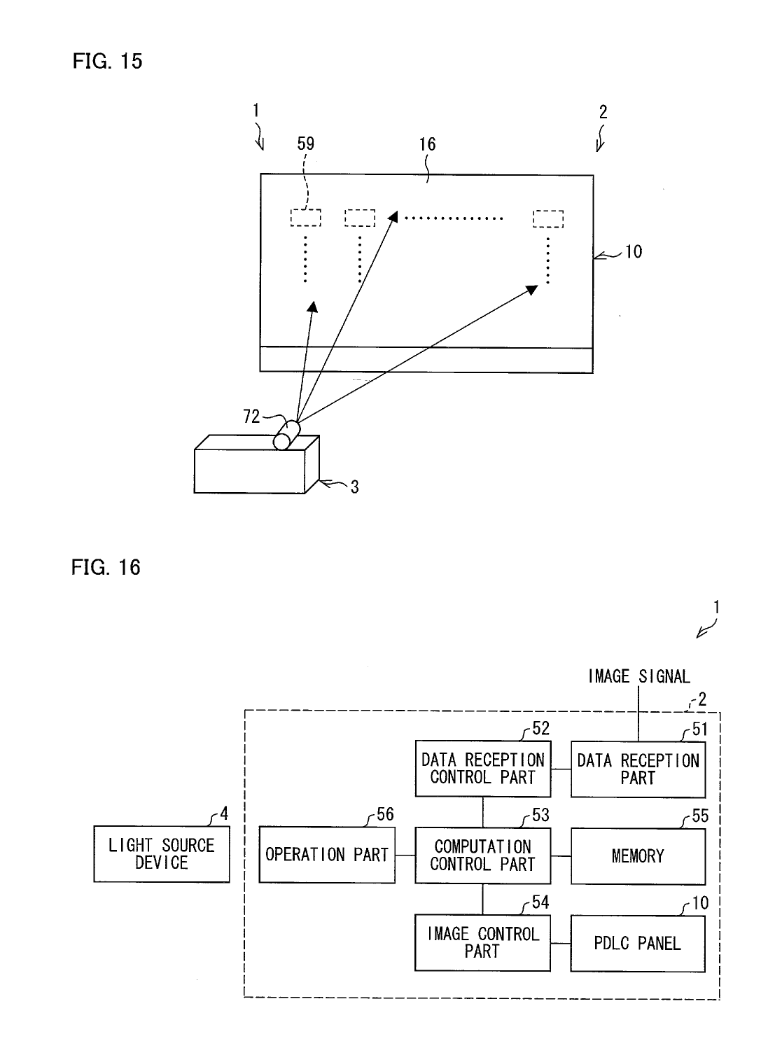

The display system 1 shown in FIG. 15 is configured so that a sensor 59 (a sensor inside a pixel) is provided within the display area 16 of the PNLC panel 10. The sensor 59 comprises a light reception element. A light source 72 for a sensor may be provided on the projector 3 to radiate light to the sensor 59 within the display area 16 of the PNLC panel 10. Unlike the sensor 58 shown in FIG. 13 and FIG. 14, the sensor 59 does not comprise a light-emitting element.

The display system 1 is configured so that the light source 72 for a sensor radiates light in at least three directions. In this way, the PNLC panel 10 comprises a sensor 59, which is a sensor inside a pixel. As a result, it is possible to detect the position within the display area 16 of the PNLC panel 10 toward which the light source 72 for a sensor radiated light. Consequently, the location of the transparent part 12 and the scattering part 13 within the display area 16 may be obtained accurately.

Therefore, the display system 1 is configured so that any misalignment of the transparent part 12 and the scattering part 13 within the display area 16 can be adjusted with precision. In this way, the display system 1 can provide the best image, devoid of any misalignment in the image on the PNLC panel 10 and the image from the projector 3.

Incidentally, in the example described with reference to FIG. 15, a light source 72 for a sensor is provided on the projector 3. The projector 3 acts as the light source 4. However, the configuration of the light source 72 for a sensor is not limited to this example.

When a light source 72 for a sensor is not provided on the light source device 4, the light source device 4 may emit light toward more than two places on the display area 16 of the PNLC panel 10. Further, the procedure described above may be performed. In this way, it is possible to detect the position within the display area 16 of the PNLC panel 10 toward which the light source device 4 radiated light. Consequently, the location of the transparent part 12 and the scattering part 13 within the display area 16 may be accurately obtained in this case as well.

Regardless of whether or not a light source 72 for a sensor is used, the positioning information obtained by the sensor 59 within the pixel 11 of the PNLC panel 10 may be sent to the light source device 4 of the projector 3 and the like. In this way, it is possible to adjust the direction in which light is radiated from the light source device 4, any distortion, and, if necessary, the focus. Thus, the best image can be provided without changing the position within the PNLC panel 10 at which a display is made.

In this illustration, a projector 3 is used as an example of the light source device 4. Further, in this illustration, the position of an image of the PNLC panel 10 is matched with the position of an image from the projector 3.

However, when light is projected to the entire surface of the display area 16 of the PNLC panel 10, it is not necessary that the position of the image of the PNLC panel 10 be matched with the position of the image from the projector 3. In addition, for instance, when the PNLC panel 10 displays a static image, or when LED is used as the light source device 4 to project a monochrome or multicolored light to the entire surface of the display area 16 of the PNLC panel 10 or to a certain part of the display area 16, it is not necessary that the position of the image of the PNLC panel 10 be matched with the position of the image from the projector 3. Moreover, when an image is displayed on only a certain portion of the scattering part 13, it is not necessary that the position of the image of the PNLC panel 10 be matched with the position of the image from the projector 3.

Therefore, in such cases, it is not necessary for the image control part 54 to convert an image, required from the computation control part 53, into an image to be displayed from the light source device 4. Neither is it necessary for the image control part 54 to send such a converted image to the light source device 4.

Therefore, in such cases, it is possible to use the display system 1 configured as illustrated in FIG. 16, for instance.

(Angle of Incidence of Light from the Light Source)

Following is a description on the angle of incidence of light from the projector 3 to the PNLC panel 10 according to the display system 1.

The refractive index of the insulating substrate used for the display panel (the relative refractive index with respect to the absolute refractive index of air) is usually in the range of approximately 1.45 to 1.65.

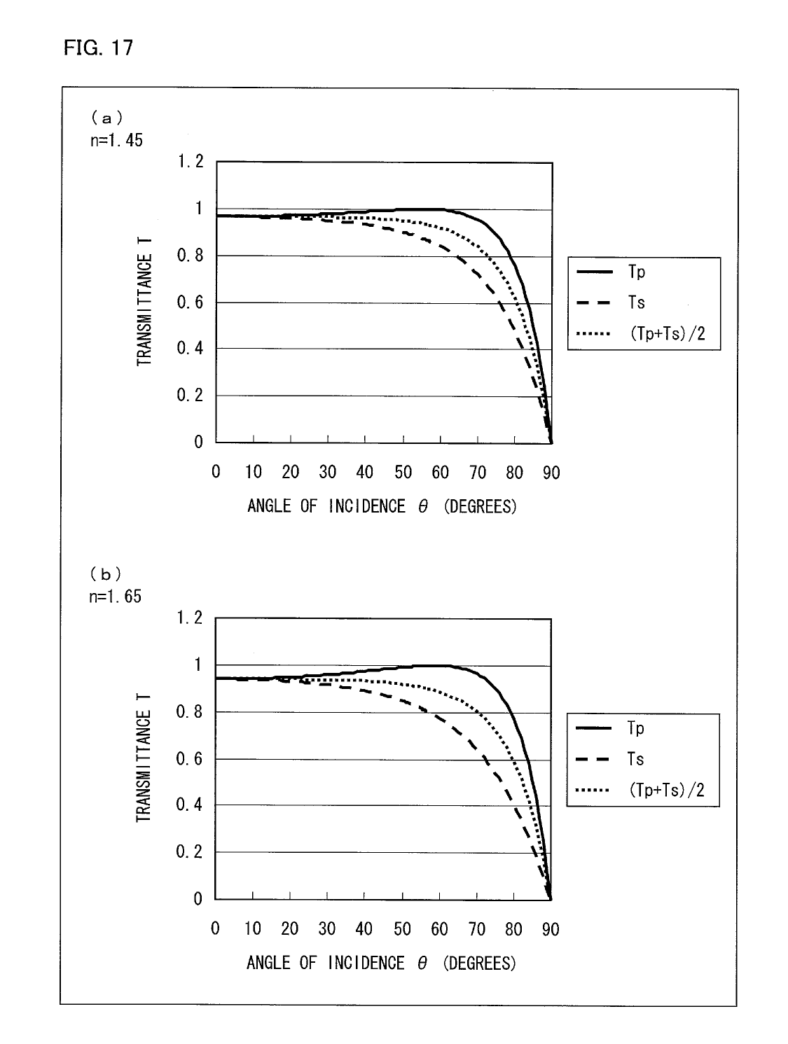

FIG. 17(a) shows a correlation between a transmittance and an angle of incidence θ of light when a refractive index of the PNLC panel 10 at a light-incident side equals one, and a relative refractive index n of a surface of the PNLC panel 10 equals 1.45. FIG. 17(b) shows a correlation between a transmittance and an angle of incidence θ of light when a refractive index of the PNLC panel 10 at a light-incident side equals one, and a relative refractive index n of a surface of the PNLC panel 10 equals 1.65.

More specifically, the example shown in FIG. 17(a) shows how a transmittance of the panel depends on the angle of incidence of light when the front surface substrate and the back surface substrate comprise a quartz glass having a relative refractive index of 1.45 with respect to the absolute refractive index of air. The example shown in FIG. 17(b) shows how a transmittance of the panel depends on the angle of incidence of light when the front surface substrate and the back surface substrate comprise a plastic substrate comprising PES (Poly Ether Sulfone) having a relative refractive index of 1.65 with respect to the absolute refractive index of air.

In FIG. 17(a) and FIG. 17(b), Tp represents a transmittance of a polarization component (P polarization) in a direction parallel to the plane of incidence of a light on the PNLC panel 10. Ts represents a transmittance of a polarization component (S polarization) in a direction perpendicular to the plane of incidence of a light on the PNLC panel 10. The angle of incidence θ represents an angle at which the angle of incidence of light (projected light) projected from the projector 3 to the PNLC panel 10 becomes the largest at a place on the PNLC panel 10 farthest from the projector 3 acting as the light source device 4.

As shown in FIG. 17(a) and FIG. 17(b), when the angle of incidence θ exceeds 80 degrees, the transmittance drops drastically. As a result, the light projected from the projector 3 cannot enter the PNLC panel 10 efficiently. However, as shown in FIG. 17(a) and FIG. 17(b), when the angle of incidence θ equals 80 degrees, a transmittance of approximately 60% can be obtained.

Thus, when the angle of incidence θ is less than or equal to 80 degrees, more preferably, less than or equal to 75 degrees, even more preferably, less than or equal to 70 degrees, still more preferably, less than or equal to 65 degrees, it is possible to obtain a display that has a high transmittance and has a brightness that is even.

Concerning the angle of incidence of light from the projector 3 to the PNLC panel 10, it is particularly preferable that the angle of incidence θ is less than or equal to Brewster's angle (hereinafter referred to as Brewster's angle θb). Angle θ is the angle at which the angle of incidence of light from the projector 3 to the PNLC panel 10 reaches its maximum.

Brewster's angle θb is an angle of incidence such that light, reflected at an interface between materials having different refractive indices, completely becomes an S polarized light. When the refractive index at the light-incident side of the PNLC panel 10 equals n1 and the refractive index at the permeating side equals n2, Brewster's angle is defined by θb=arctan(n2/n1). At this angle, the polarization component (P polarization) in a direction parallel to the plane of incidence has a reflectance of zero.

For incidence of light from air to glass, Brewster's angle θb equals approximately 56 degrees. For incidence of light to a plastic substrate having a relative refractive index of 1.65, Brewster's angle θb equals approximately 59 degrees.

Considering also the polarization component (S polarization) in a direction perpendicular to the plane of incidence, the transmittance does not change significantly as long as the angle of incidence θ is less than or equal to Brewster's angle. However, when the angle of incidence θbecomes greater than Brewster's angle, the reflectance increases rapidly. As a result, the amount of light that enters the PNLC panel 10 from the projector 3 decreases.

Therefore, when the projector 3 is installed so that the angle, at which the angle of incidence θ of light from the projector 3 to the PNLC panel 10 reaches its maximum, exceeds Brewster's angle by a large margin, the brightness of the display shown within the PNLC panel 10 becomes uneven.

In particular, when the angle of incidence θ exceeds 80 degrees, the transmittance drops rapidly, as described above. Therefore, it is preferable that the angle of incidence θ be less than or equal to 80 degrees.

### (Method of Manufacturing a PNLC Panel)

Next, a method of manufacturing the PNLC panel 10 is described.

The PNLC panel 10 can be obtained, for example, by enclosing a mixture of polymerizable monomer, photopolymerization initiator, and positive type liquid crystal between the substrate 20 and the substrate 30 using a dripping injection method, and then performing an ultraviolet exposure (i.e., a photo polymerization).

There is no specific limitation on the types of polymerizable monomer, photopolymerization initiator, and positive type liquid crystal. It is possible to use known ingredients that are normally used to manufacture a PNLC panel. The composition (quantity used) of the mixture can be set according to conventional practice, and is not limited in any particular manner. Although these types and composition are not described here, a skilled person would be knowledgeable of such types and composition, and would be able to put them into practice.

Incidentally, the PNLC panel 10 according to the present embodiment does not comprise any CF (does not have any color). Therefore, when the PNLC undergoes exposure, ultraviolet absorption does not occur regardless of whether the exposure is conducted from the substrate 20 side or from the substrate 30 side. In other words, even if exposure is conducted from the opposing substrate side where a CF is usually placed, ultraviolet absorption does not occur. Therefore, an exposure device providing an extremely strong lighting intensity is not needed. Using a versatile exposure device is enough.

As described above, the PNLC display mode includes a normal mode and a reverse mode. In general, in the normal mode, not applying any electric field leads to a light-scattering state, whereas applying an electric field leads to a light-transmitting state. In the reverse mode, not applying any electric field leads to a light-transmitting state, whereas applying an electric field leads to a light-scattering state.

Overall, the mixture used as an ingredient of PNLC exhibits liquid crystallinity.

A PNLC panel 10 in normal mode can be obtained by performing an ultraviolet exposure on the mixture at a temperature greater than or equal to the temperature (Tₙᵢ) at which the phase of the mixture changes from a liquid crystal phase to an isotropic phase, more preferably, greater than or equal to the temperature at which the phase of the mixture changes from a liquid crystal phase to an isotropic phase, and, less than or equal to the temperature at which the positive type liquid crystal used in the mixture changes its phase from a liquid crystal phase to an isotropic phase.

The PNLC panel 10 in normal mode is configured so that, pertaining to the polymerizable monomer, a material that does not have an aeolotropic refractive index (non-liquid-crystal monomer) is used for the polymer part (the area having a high polymer concentration when a phase separation is performed by ultraviolet polymerization) when the PNLC is formed. The polymerizable monomer is an ingredient of the mixture described above. The liquid crystals (liquid crystal molecules) of the liquid crystal droplet (liquid crystal drop, liquid crystal grain) that is obtained are oriented at random in a direction of the panel surface.

Meanwhile, a PNLC panel 10 in reverse mode can be obtained by performing an ultraviolet exposure on the mixture at a temperature less than or equal to the temperature (Tₙᵢ) at which the phase of the mixture changes from a liquid crystal phase to an isotropic phase, more preferably, less than or equal to the temperature at which the phase of the mixture changes from a liquid crystal phase to an isotropic phase, and, greater than or equal to the crystallization temperature of the mixture or the temperature at which the obtained PNLC becomes a smectic layer.

The PNLC panel 10 in reverse mode is configured so that, pertaining to the polymerizable monomer, a material that has an aeolotropic refractive index (liquid crystal monomer) is used for the polymer part when the PNLC is formed. The polymerizable monomer is an ingredient of the mixture described above. The liquid crystals within the liquid crystal droplet that is obtained are oriented so that the refractive index of the polymer matches the refractive index of the liquid crystal.

When the PNLC panel 10 is configured so that a PNLC in normal mode is used as the PNLC layer 40, a more effective scattering can be obtained by forming the PNLC so that, when the PNLC panel 10 undergoes a planar projection by a light projected from the projector 3, the liquid crystal droplets are aligned perpendicular to the direction in which the light projected from the projector 3 enters the PNLC panel 10. The PNLC layer is a light scattering layer. When a PNLC in reverse mode is used, it is more effective to place the long axis of the liquid crystal molecule of the liquid crystal droplets perpendicular to the direction in which the light projected from the projector 3 enters the PNLC panel 10.

A method of aligning the liquid crystal droplets in these ways is described below as a preferable embodiment of the PNLC.

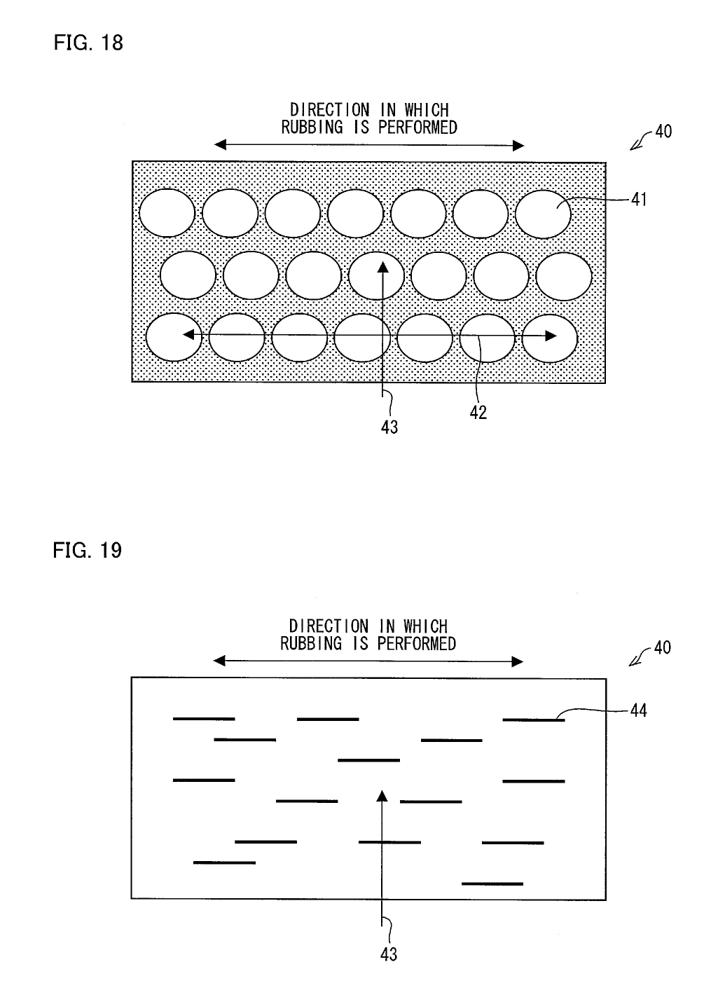

FIG. 18 is a cross-sectional view showing a direction in which liquid crystal droplets 41 of the PDLC layer 40 are oriented in a normal mode. FIG. 19 is a cross-sectional view showing a direction in which liquid crystal droplets 41 of the PDLC layer 40 are oriented in a normal mode.

The PNLC does not necessarily require a polarizing plate or an orienting plate. At the plane facing the PNLC layer 40 of the substrates 20 and 30, an organic film such as a polyimide film or an oriented film comprising an inorganic film may or may not be provided.

When the substrates 20, 30 do not undergo an orienting procedure such as rubbing or a photo-alignment operation, the liquid crystal droplets of the PNLC (the region having a high liquid crystal concentration when a phase separation is performed by ultraviolet polymerization) after the ultraviolet exposure are formed at random within the substrate surface.

When the PNLC panel 10 is in a light-scattering state at this time, the intensity of the scattered light of the light entering from the normal direction of the PNLC panel 10 (the normal direction of the panel) is generally isotropic, seen from the normal direction of the panel. This phenomenon might be more or less affected by the wiring.

However, when an orienting procedure such as rubbing is performed on a surface of the substrates 20, 30 that faces the PNLC layer 40, the directions of the rubbing performed on the substrates 20, 30 are set to be parallel to one other or anti-parallel to one another. Further, the ingredients of the PNLC and the conditions of the ultraviolet exposure are set to be optimum. In this way, the liquid crystal droplets 41 can be positioned (aligned) to line up parallel to the substrate surface along the rubbing direction.

For the surface processing (orienting procedure) performed on the substrates 20, 30, a method other than rubbing may be employed, such as forming minute grooves.

The PNLC layer 40 shown in FIG. 18 is configured so that, when the PNLC panel 10 is in a light-scattering state, the intensity of scattered-light entering from the normal direction of the panel becomes acutely scattered in a direction perpendicular to the orienting direction 42 of the liquid droplets 41 seen from the normal direction of the panel.

Accordingly, when the PNLC panel 10 is configured as the PNLC panel comprising liquid crystal droplets 41 aligned as shown in FIG. 18, it is preferable to install the projector 3 so that, when the PNLC panel 10 undergoes a planar projection by a light projected from the projector 3, the orienting direction 42 of the liquid crystal droplets 41 is perpendicular to the incident direction 43 in which the light projected from the projector 3 enters the PNLC panel 10. In such a case, the light from the projector 3 entering the PNLC panel 10 can be scattered more effectively before being sent to the viewer.

Meanwhile, in reverse mode, when the rubbing direction of the substrate 20 and the rubbing direction of the substrate 30 are set to be parallel to one another or anti-parallel (parallel to each other but facing the opposite direction) to one another, the long axis of the liquid crystal within the liquid crystal droplet 41 (see FIG. 18) is oriented in a direction parallel to the rubbing direction, as shown in FIG. 19.

The PNLC layer 40 shown in FIG. 19 is configured so that, when the PNLC panel 10 is in a light-scattering state, the intensity of scattered-light entering from the normal direction of the panel becomes acutely scattered in a direction perpendicular to the long axis 44 (direction of the long axis) of the liquid crystal seen from the normal direction of the panel.

Accordingly, when the PNLC panel 10 is configured as the PNLC panel comprising liquid crystal droplets 41 having liquid crystal molecules with long axes 44 being aligned parallel to the rubbing direction as shown in FIG. 19, it is preferable to install the projector 3 so that, when the PNLC panel 10 undergoes a planar projection by a light projected from the projector 3, the long axes 44 of the liquid crystal molecules are perpendicular to the incident direction 43 in which the light projected from the projector 3 enters the PNLC panel 10. In such a case, the light from the projector entering the PNLC panel 10 can be scattered more effectively before being sent to the viewer.

### (Electronic Device)

Next, an application of the display system 1 comprising the PNLC panel 10 and the reflecting part 14, or comprising the display device 2 comprising the PNLC panel 10 and the reflecting part 14 is described. In addition, an example of an electronic device employing the PNLC panel 10 and the reflecting part 14 or the display system 1 is described.

According to the present embodiment, when a colored presentation is displayed, the projector 3 conducts the expression of the color, as described above. Therefore, the PNLC panel 10 need not comprise any CF. Hence, the transmittance of the PNLC panel 10 can be increased.

In this way, when the projector 3 is used as the light source device 4 and a high-definition display is made with a projector mode, the PNLC panel 10 can lower (reduce) its resolution. Therefore, in this case, the transmittance of the PNLC panel can be enhanced even further. Hence, when a scattering/reflection display (light-scattering/light-reflection display) is performed by the PNLC panel 10 and the reflecting part 14, the reflection display may be performed by the transparent part 12 having a high level of transparency.

In this way, the PNLC panel 10 and the reflecting part 14 are configured so that light (image) can be reflected by the reflecting part 14 placed at the back side of the PNLC panel 10. Therefore, a crisp display can be provided. Hence, the PNLC panel 10 and the reflecting part 14 may be effectively applied to portable telephones, electronic dictionaries, and the like.

Incidentally, when the display system 1 is applied to an electronic dictionary, etc., a projector mode can be used only when figures or photographs are displayed. By using a projector mode when figures or photographs are displayed, a display can be provided in an aesthetically appealing manner. Meanwhile, when text and the like are displayed, and it is not necessary to display a colored presentation, only the PNLC panel 10 may be driven to perform an uncolored light-scattering/light-transmitting display. By turning off the output of the projector 3, the power consumption can be reduced.

Further, as shown in FIG. 7, by providing a scattering part 13 inside the transparent part 12 of the PNLC panel 10, and displaying a filmed image onto this scattering part 13 as a projected image, a striking display can be provided, as if the projected image is looming out.

Incidentally, by installing the PNLC panel 10 and the reflecting part 14 in a place with a background like a partition or a glass window, a more striking display may be provided. Using the PNLC panel 10 for a propped-up notice is extremely effective in grabbing the attention of onlookers.

Thus, the display system 1 can display colors, and can be used effectively as a display system for a digital sign having a strong eye-catching quality.

Further, the display system 1 can be used effectively for a theater system, a display in office space, a TV (television) conferencing system, and the like.

Moreover, by combining the PNLC panel 10 and the reflecting part 14 with a space-saving projector 3 as the light source device 4, an application to a portable terminal such as a portable telephone can be made in a favorable manner.

### Second Embodiment

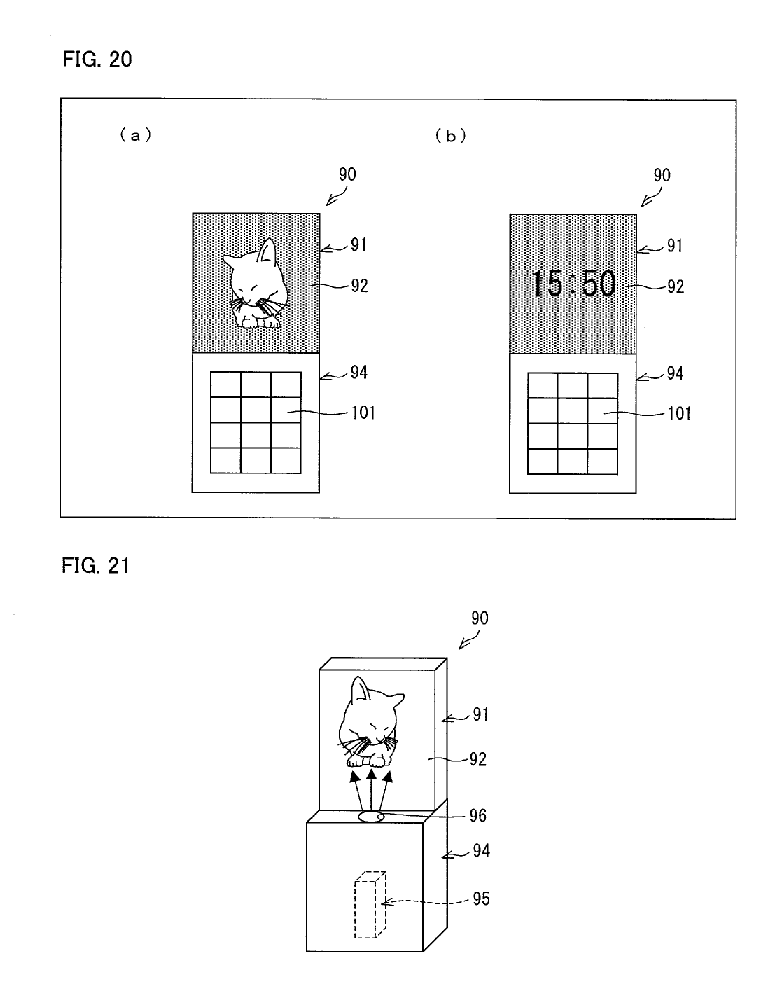

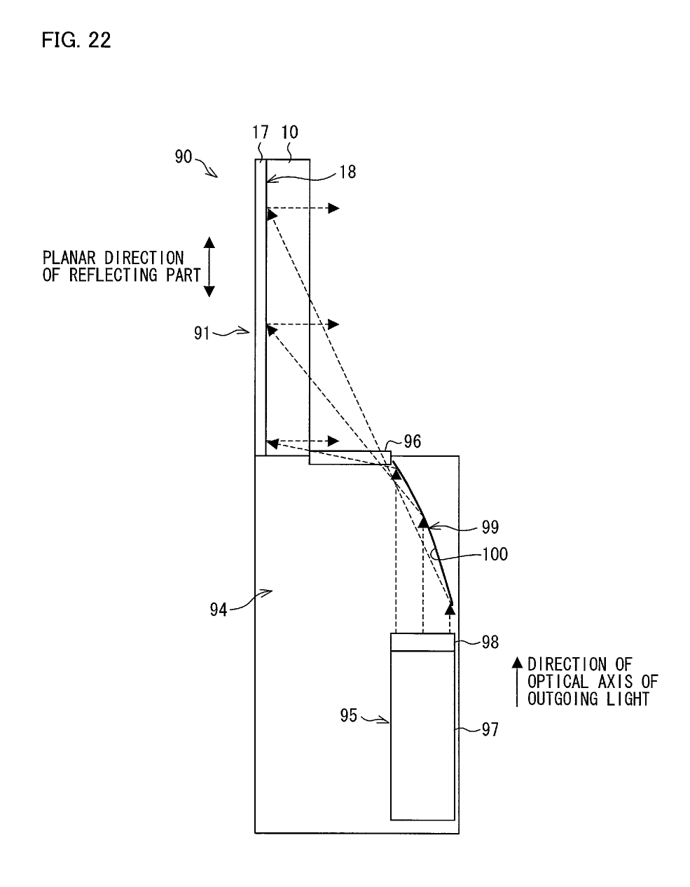

Next, another embodiment of the present invention is described with reference to FIG. 20(a), FIG. 20(b), FIG. 21, and FIG. 22.

For ease of explanation, the components having the same features as the components already illustrated in the figures pertaining to the first embodiment are labeled with the same reference numerals. Duplicative explanations of such components are not provided here.

An example of the present embodiment is described with reference to FIG. 20(a), FIG. 20(b), FIG. 21, and FIG. 22. In this example, the display system 1 according to the first embodiment is applied to a portable terminal such as a portable telephone.

First, an example applying the display system 1 to a portable telephone is described as an example of a portable terminal.

FIG. 20(a) and FIG. 20(b) are both frontal views showing an overall configuration of a portable telephone according to the present embodiment. FIG. 21 is a perspective view showing an overall configuration of the portable telephone shown in FIG. 20.

As shown in FIG. 20(a) and FIG. 20(b), the portable telephone 90 according to the present embodiment comprises a main body of the device 94 comprising a display part 91 and an operational key 101 (operation part) as shown in FIG. 20(a), FIG. 20(b), and FIG. 21. The display part 91 displays on a display surface 92, image that a user views and hears, such as graphic figures, time, and telephone numbers, etc. The operational key 101 receives operations for using the portable telephone 90 as a telephone. In addition, the operational key 101 receives operations for displaying images onto the display part 91.

The display party 91 employs the display device 2 according to the first embodiment as a display device and a display panel. As described later, a PNLC panel 10 is placed on the front surface of the display part 91. On the back surface of the display part 91, a reflecting part 17 is placed. This reflecting part 17 corresponds to the reflecting part 14. Further, as shown in FIG. 21, the main body of the device 94 comprises a small projector (light source device) 95 as a light source device that radiates light from the display surface 92 side of the display part 91.

In other words, the portable telephone 90 is configured so that the small projector 95 is embedded inside the main body of the device 94, and light (image) is outputted from a front side of a vicinity of the display panel of the display part 91 towards the display surface 92 of the display part 91.

In addition, a lens (an aspherical concave reflecting mirror) is provided inside the main body of the device 94 of the portable telephone 90. The lens is corrected so that there will be no distortions in the image projected from an opening window 96 onto the display surface 92 of the display panel (i.e., the PNLC panel 10) used in the display part 91.

Next, a projection of an image by the small projector 95 onto the display part 91 is described below with reference to FIG. 22.

FIG. 22 is a cross sectional view showing an overall configuration of the portable telephone 90 shown in FIG. 20(a), FIG. 20(b), and FIG. 21.

As shown in FIG. 22, the display part 91 is configured so that the reflecting part 17, corresponding to the reflecting part 14, is placed at the back side. The PNLC panel 10 is placed on the surface of the reflecting surface 18 of the reflecting part 17.

Further, as shown in FIG. 22, the small projector 95 comprises an image output part 97 and a projection lens 98. The image output part 97 outputs an image formed by the light-modulating part. The projection lens 98 magnifies the image outputted from the image output part 97.

A light-modulating part using laser or a light-modulating part using a DMD (Digital Micro-Mirror Device; registered trademark) and liquid crystal, for example, may be used as the light-modulating part of the small projector 95.

In FIG. 22, light projected from the projection lens 98 of the small projector 95 and light reflected from the reflecting part 17 are shown as dotted arrows.

In other words, light projected from the image output part 97 of the small projector 95 is reflected by the reflection surface 100 of the aspherical concave reflecting mirror (reflecting part) 99 provided inside the main body of the device 94. The reflected light then passes through the opening window 96 provided at the top surface of the main body of the device 94, and is projected onto the display surface 92 of the display part 91. The projected light is then reflected by the reflection surface 18 of the reflecting part 17 provided at the back side inside the display part 91. In this way, an image is displayed on the display surface 92 of the display part 91.

Incidentally, the dotted arrows shown in FIG. 22 are simplified for explanatory purposes. The dotted arrows in FIG. 22 therefore do not provide a strict representation of light before an image is formed, etc.

The portable telephone 90 comprises an aspherical concave reflecting mirror 99 that reflects light projected by the small liquid crystal projector 95. Thus, even if the direction of the optical axis of light projected from the small projector 95 is set to be parallel to the planar direction of the reflecting part 17, the light projected from the small projector 95 is reflected at the reflecting part 17. As a result, an image can be displayed at the display surface 92 of the display part 91.

The portable telephone 91 is configured so that the small projector 95 is placed inside the main body of the device 94 in a way that the direction of the optical axis of light projected from the small projector 95 is parallel to the planar direction of the reflecting part 17. Consequently, the small projector 95 and the display part 91 take up less space. Hence, the size of the main body of the device 94 can be reduced.

Furthermore, the reflection surface 18 of the reflecting part 17 comprises an irregular, corrugated shape so that the light projected from the small projector 95 can be reflected toward the frontal direction.

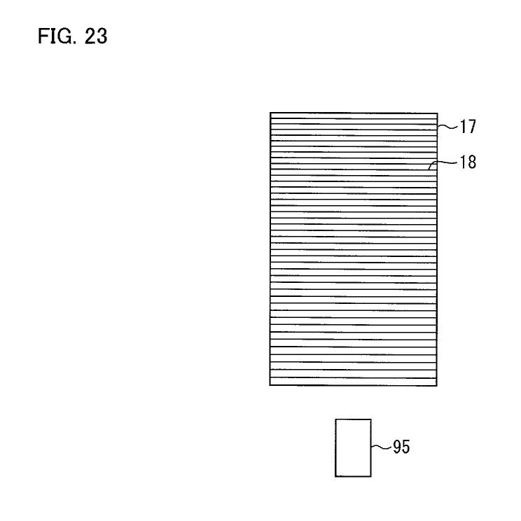

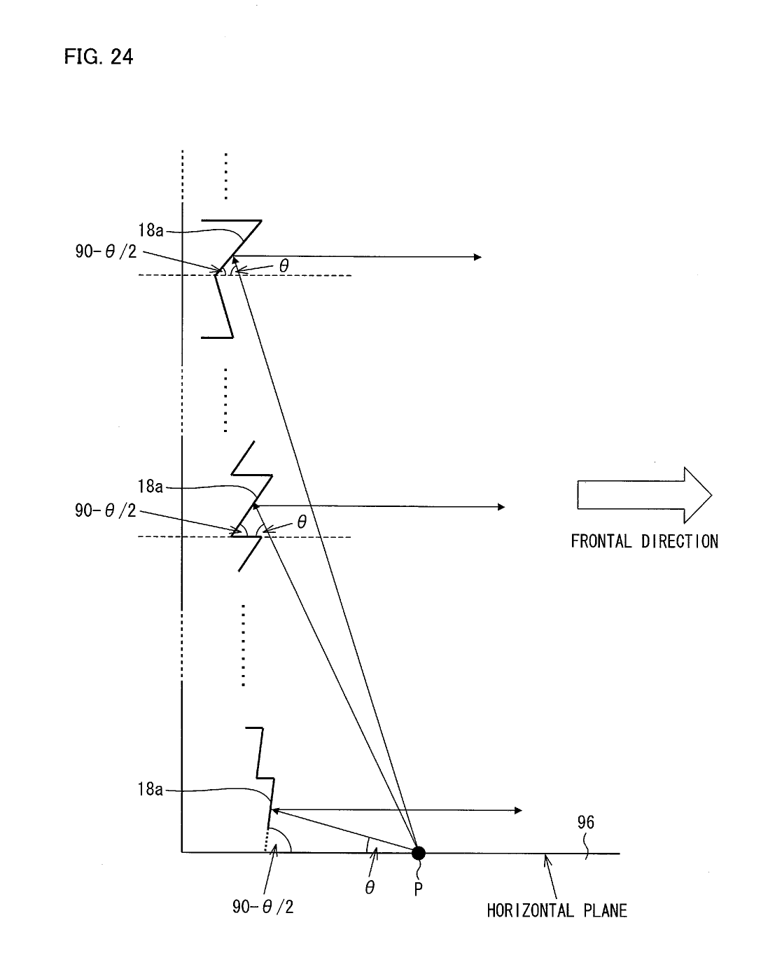

FIG. 23 is a planar view showing a configuration of the reflecting part 17. FIG. 24 is a diagram illustrating how a reflection is performed on a reflecting part. As shown in FIG. 23 and FIG. 24, when the reflecting part 17 is seen from a planar view, the reflection surface 18 of the reflecting part 17 comprises a plurality of slopes 18a. These slopes 18a form an irregular, corrugated shape. The slopes 18a are placed so that the pitch (interval) becomes gradually smaller from the side at which the small projector 95 is placed (i.e., the side closer to the light source) to the opposite side.

In other words, the slopes 18a of the reflection surface 18 forming the irregular, corrugated shape are placed so that the angle with respect to a horizontal line becomes gradually smaller from the end part closer to the small projector 95, toward the end part located farthest from the small projector 95.

As a result, a greater portion of the light projected from the small projector 95 can be reflected toward the frontal direction by the reflection surface 18 of the reflecting part 17. In this way, an image having a high contrast can be displayed.

More specifically, as shown in FIG. 24, the horizontal plane is defined to be the surface parallel to the frontal direction of the portable telephone 90. Point P is set as an arbitrary point on the horizontal plane of the opening window 96. In other words, the horizontal plane is perpendicular to the direction of the optical axis of the light projected from the small projector 95.

The angle between the horizontal plane and the optical axis of the light projected from point P is set to be the angle θ. The angle between the slope 18a and the horizontal plane is (90−(θ/2))°. The slope 18a forms the irregular, corrugated shape of the reflection surface 18.

In other words, for instance, when light is passed through point P so that the angle θ between the light's optical axis and the horizontal plane is small, and this light reflects at the slope 18a (the slope 18a located at a side closer to the small projector 95), there is an increase in the angle (90−(θ/2))° formed between the slope 18a and the horizontal plane. Meanwhile, when light is passed through point P so that the angle θ between the light's optical axis and the horizontal plane is large, and this light reflects at the slope 18a (the slope 18a located at a side farther from the small projector 95), there is a decrease in the angle (90−(θ/2))° formed between the slope 18a and the horizontal plane.

As a result, a greater portion of the light projected from the small projector 95 can be reflected toward the frontal direction.

Incidentally, the reflection surface 18 of the reflecting part 17 need not be configured as described above so that the angle with respect to the horizontal plane gradually becomes smaller from the side closer to the small projector 95 towards the side farthest from the small projector 95. The inclining angle with respect to the horizontal plane may be constant. Further, the reflection surface 18 need not comprise an irregular, corrugated shape. The reflection surface 18 may be a flat planar surface.

When the portable telephone 90 displays a colored presentation, the image of the display part 91 may be synchronized with the image from the small projector 95 according to the method described in the first embodiment.

The portable telephone 90 is configured so that, when a colored presentation is displayed, the small projector 95 conducts the expression of the color(s) used. Therefore, it is possible to increase the transmittance of the PNLC panel 10 comprised in the display part 91.

Further, if the high-definition display is conducted by the small projector 95, it is possible to lower the resolution of the PNLC panel 10 comprised in the display part 91. Thus, the transmittance of the PNLC panel 10 can be further enhanced. Therefore, when the portable telephone 90 performs a scattering/transparent display (reflection display), it is possible to provide a transparent display (reflection display) exhibiting a high transparency.

Incidentally, when a scattering/transparent display (reflection display) is made on the display part 91 without any colored presentation, a graphic figure display (scattering display) may be created by the scattering part 13 by applying electric voltage to the PNLC panel 10 and forming a transparent part 12 and a scattering part 13 without any output from the small projector 95 inside the main body of the device 94. In this case, it is possible to save the electric power used for the output of the small projector 95. Thus, a display may be provided with low power consumption.

The aesthetic feature of small devices such as the portable telephone 90 may be enhanced by curving the panel surface.

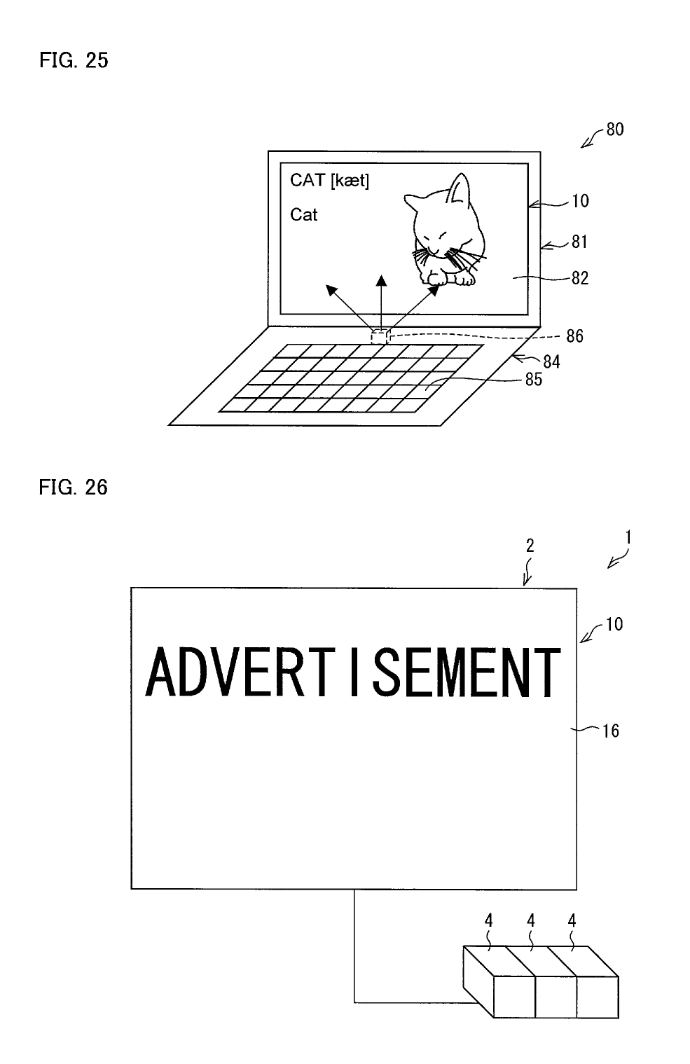

Further, as shown in FIG. 25, the display system 1 may be applied to an electronic dictionary acting as a portable terminal. FIG. 25 is a perspective view showing an overall configuration of an electronic dictionary according to the present embodiment.

As shown in FIG. 25, the electronic dictionary comprises a main body of the device 84 comprising a display part 81 and an operational key 85 (operation part). The display part 81 displays on a display surface 82, image that a user sees, such as graphic figures and letters, etc. The operational key 85 receives operations for using the electronic dictionary. In addition, the operational key 85 receives operations for displaying images onto the display part 81.

A small projector 86 is provided inside the main body of the device 84, as shown in FIG. 25. Similar to the configuration of the portable telephone 90, the electric dictionary 80 is configured so that the small projector 86, placed in the main body of the device 84, projects light (image) from a front side of a vicinity of the display panel of the display part 81 towards the display surface 82 of the display part 81.

The display surface 82 of the electronic dictionary 80 is larger than the display surface 92 of the portable telephone 90. However, the display surface 82 cannot be placed far away from the small projector 86. Therefore, it is preferable that a short focus projector be used as the small projector 86.

By using a short focus projector as the small projector 86, an image can be projected onto the entire surface of the display surface 82 even if, for example, the size of the display surface 82 is five inches, and the distance (projector distance) with respect to the display surface 82 of the small projector 86 is approximately 5 cm.

In this way, the electronic dictionary 80 configured in this way can provide the same effects as the portable telephone described 90 described above. In particular, the electronic dictionary 80 is configured so that, when the display surface 82 displays only letters, no output is made by the small projector inside the main body of the device 84. A projector mode is used, i.e., an output of the small projector is made, only when figures and pictures are displayed on the display surface 82. As a result, images can be displayed aesthetically and with low power consumption.

### Third Embodiment

Next, another embodiment of the present invention is described with reference to FIG. 26.

For ease of explanation, the components having the same features as the components already illustrated in the figures pertaining to the first and second embodiments are labeled with the same reference numerals. Duplicative explanations of such components are not provided here.

FIG. 26 is a skeletal diagram showing an overall configuration of a display system 1 using a plurality of light source devices.

Incidentally, FIG. 26 illustrates an example in which a light source device 4 is placed at the front side of the PNLC panel 10 seen from a viewer. However, the location at which the light source device 4 is placed is not limited to this example.

As shown in FIG. 26, a plurality of light source devices 4 may be provided. In other words, the display system 1 may be configured to comprise a plurality of light source devices 4.

In this case, for instance, the plurality of light source devices 4 can be configured to be image-projecting projectors comprising three projectors: a projector projecting R (red) colored light, a projector projecting G (green) colored light, and a projector projecting B (blue) colored light.

Instead of projecting one image from the light source device 4, each of the light source devices 4 can project light onto a portion of the display area 16 of the PNLC panel 10. If such a configuration is made, the projector 3 can comprise three projectors: one for R-colored light, another for G-colored light, and another for B-colored light. In this way, a colorful, rich display can be provided by showing different colors in each region (i.e., for each area to which each of the light source devices 4 projects light). In this case, a Y (yellow) colored region can be created by the overlapping portion of the R-colored light and the G-colored light.

In this case, as described above, for instance, a colorful, rich display can be provided by employing a light source device 4 for R-colored light, another light source device 4 for G-colored light, and another light source device 4 for B-colored light, and by showing different colors in each region to which each one of these light source devices 4 projects light.

Thus, a plurality of light source devices 4 may be used so that each light source device 4 projects light to a portion of the display area 16 of the PNLC panel 10. As a result of this configuration, light can be projected onto the entire surface of the display area 16 of the PNLC panel 10, or onto a plurality of portions of the display area 16.

Incidentally, when a plurality of LEDs are used as the light source device 4, for example, the light source device 4 may comprise a plurality of LEDs and a circuit substrate mounted with these plurality of LEDs.

The light source device 4 may be configured to be a light source device with a simple structure so that a single light or a plurality of light undergoes an ON/OFF control (light is turned on/light is turned off), for example. This configuration is different from a projector projecting a graphic figure (image) as a multitude of colors by using a CRT (cathode-ray tube) or liquid crystal to project an enlarged image.

The graphic figure displayed by the display system 1 may be an animated image such as a footage. The display system 1 may also display a static image such as letters by placing the scattering part 13 having a predetermined shape at a predetermined position, and by using an LED or monochrome laser projector, an overhead projector, and a slide projector, etc., as the light source device 4. In this configuration, a scattering part 13 shaped like a letter may be projected with a monochrome or multicolored light by the light source device 4 as shown in FIG. 26. As a result, a colored letter can be displayed as if it is floating out from a mirror.

Here, the scattering part 13 is configured to have a predetermined shape and is placed at a predetermined position. Thus, a static image such as a letter or time or date is displayed, for example. In such a case, it is not necessary that the PNLC panel 10 undergo an active-matrix-type driving. In this case, an electric voltage application member (electric field application member) may be formed on the PNLC panel 10. Examples of the electric voltage application member include a segment electrode or an electrode formed to have a predetermined shape corresponding to the shape of the image that is to be displayed. These electrodes can be turned on or off to create a display.

### Fourth Embodiment

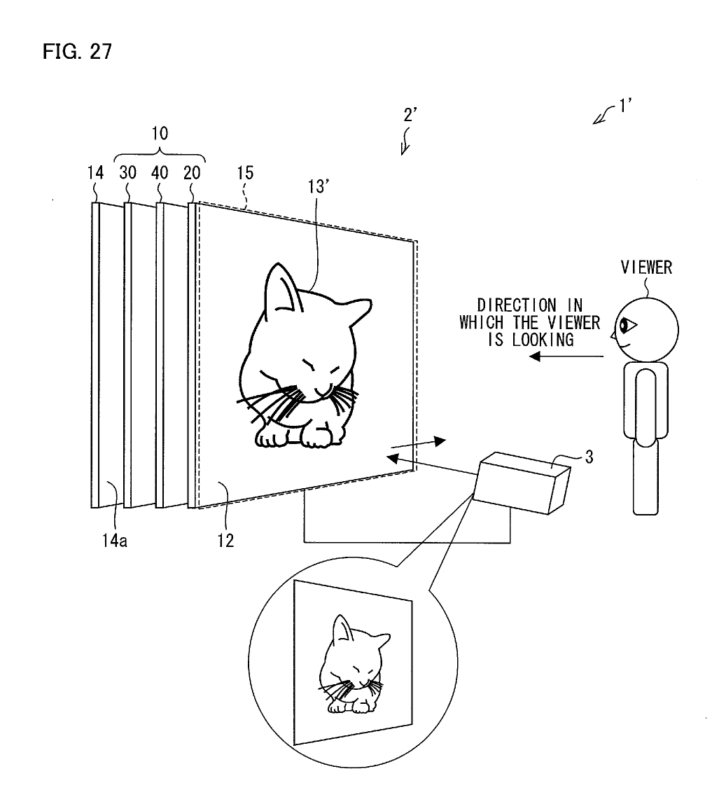

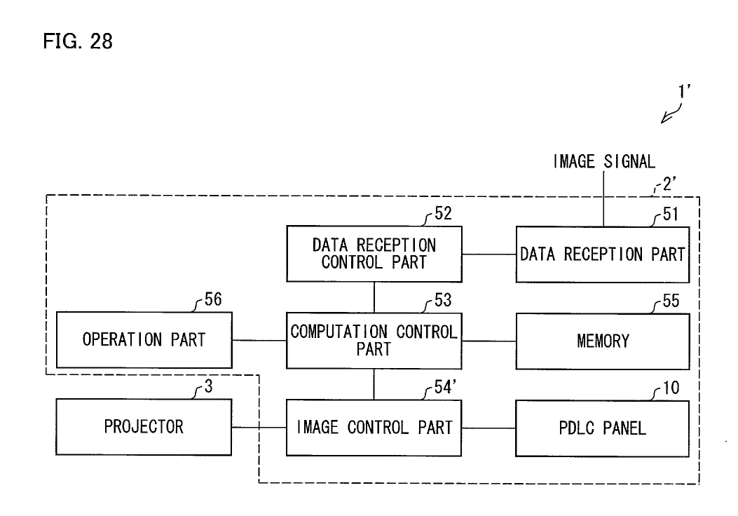

Next, another embodiment of the present invention is described with reference to FIG. 27 and FIG. 28.

FIG. 27 is a broken-down perspective view showing an overall configuration of a display system according to the present embodiment. In FIG. 27, a display panel is shown in a skeletal manner by breaking down the display panel into its components.

FIG. 28 is a block diagram showing an example of an overall configuration of a display system according to the fourth embodiment.

As shown in FIG. 27 and FIG. 28, a display system 1′ (liquid crystal display system) according to the present embodiment comprises a display device 2′ and a projector 3.

The display device 2′ is different from the display panel 2 in that the display device 2′ comprises an image control part 54′ instead of the image control part 54 comprised by the display panel 2. Other configurations of the display device 2′ are similar to the configurations of the display panel 2.

As described above, the image control part 54 of the display panel 2 controls the image that is to be outputted from the projector 3. This image looks as if the contour of an image to be displayed on the PNLC panel 10 (figures, letters, and the like) are filled out (having underwent a binary, thresholding procedure). The image control part 54 sends this created image (hereinafter may be referred to as a “binarized image”) to the PNLC panel 10. The PNLC panel 10 then displays the binarized image sent from the image control part 54.

In this way, when the direction of the regular reflection is bright, seen from the viewer, i.e., when the conditions for performing a reflection display of an image projected from the projector 3 is not optimal, a contrast with the transparent part 12 can be made more striking by configuring the scattering part 13 as a binarized image.

The projector 3 outputs an image to be displayed on the PNLC panel 10 (figures, letters, and the like). The image control part 54′ of the display device 2′ according to the present embodiment does not perform any binary, thresholding procedure on this image. Instead, the image control part 54′ sends to the PNLC panel 10, an image displayed through a gradation display. The PNLC panel 10′ displays a scattered part 13′ (hereinafter may be referred to as a gradation image) accompanying a gradation display, instead of any binarized image sent from the image control part 54′.

In other words, figures and letters, etc., are displayed in the scattering part 13′ displayed by the PNLC panel 10. Thus, a region exhibiting weak scattering and a region exhibiting strong scattering are created.

Similarly, the projector displays an image (figures, letters, and the like) to the scattering part 13′ displayed on the PNLC panel 10.

For example, when the frontal direction (direction of the regular reflection) of the PNLC panel 10 is sufficiently darker than the brightness of the display created by the light from the light source device 4, the image on the PNLC panel 10 need not undergo a binary, thresholding procedure. Instead, a gradation image, similar to the image by the projector 3, may be displayed.

Thus, when the direction of the regular reflection of the PNLC panel 10 is sufficiently darker than the brightness of the display created by the light from the projector 3, i.e., when the conditions for performing a reflection display of an image projected from the projector 3 is favorable, the contrast is sufficiently large even if the scattering part 13 shows a gradation image. As a result, the displayed image is seldom difficult to see.

In this way, the image control part 54′ need not perform a binary, thresholding procedure. Therefore, an image can be displayed with the display device 2′ having a simple configuration.

If the direction of the regular reflection of the PNLC panel 10 is dark, and a gradation display is performed by the PNLC panel 10 as well, the contrast of the projector 3 can be enhanced adequately. At the same time, it is possible to increase the number of tones that can be displayed.

### Fifth Embodiment

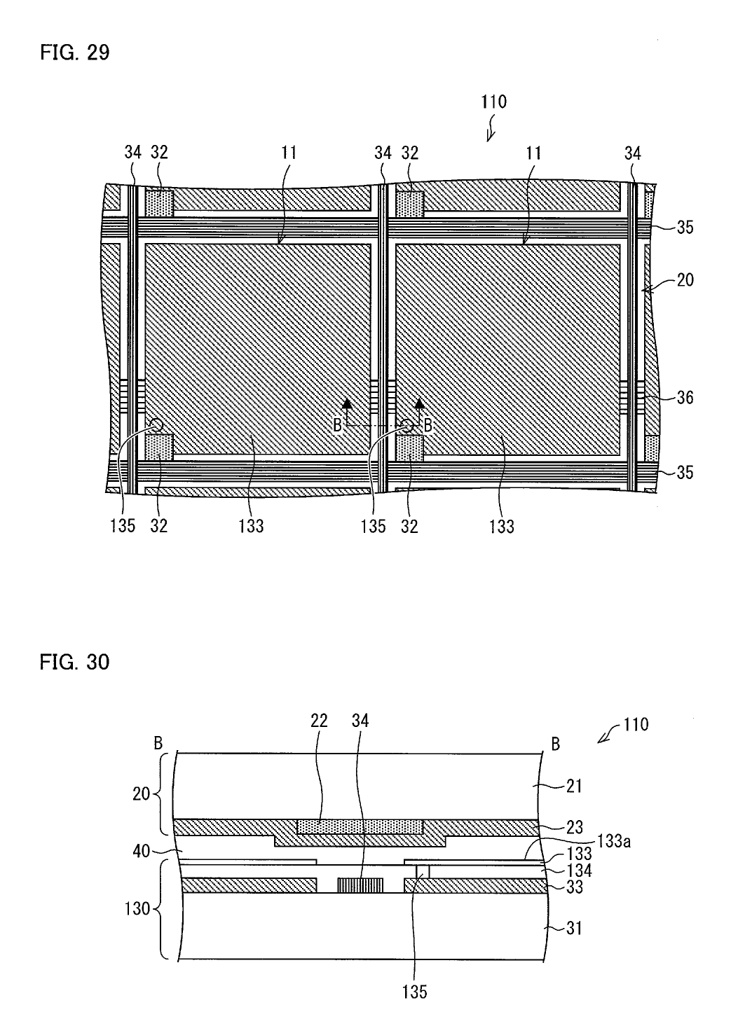

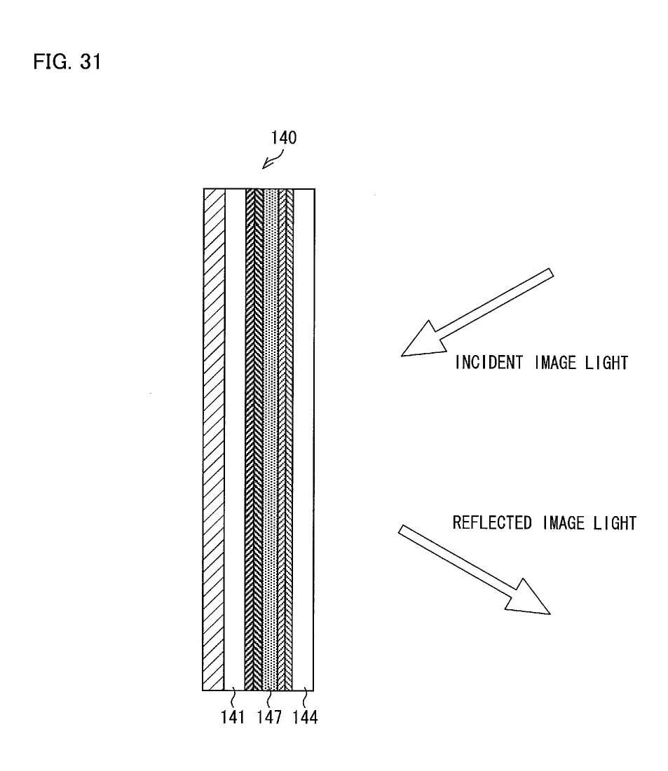

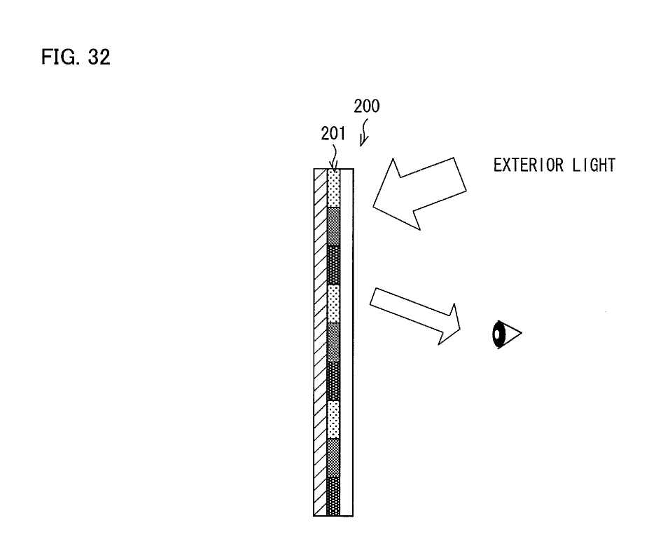

Next, another embodiment of the present invention is described with reference to FIG. 29 and FIG. 30. FIG. 29 is a planar view showing an overall configuration of a key component of an active matrix substrate of a display panel according to the present embodiment. FIG. 30 is a skeletal cross-sectional view showing an example of an overall configuration of a display panel according to the present embodiment. The cross-sectional view in FIG. 30 is obtained by cutting along line B-B shown in FIG. 29.

As described with reference to FIG. 1, the reflecting part 14 is provided outside the PNLC panel 10. The present embodiment is different from other embodiments in that, according to the present embodiment, a reflecting part 133 is provided inside a PNLC panel 110.

The display system 1 according to the present embodiment comprises a PNLC panel (display panel) 110 instead of the PNLC panel 10 and the reflecting part 14.

The PNLC panel 110 does not comprise any coloring layer. The PNLC panel 110 is configured so that a light-transmitting region and a light-scattering region can be formed selectively. A reflecting part 133 is provided inside the PNLC panel 110. A projector 3 projects monochrome or multicolored light to the PNLC panel 110 from the front side of the PNLC panel 110 (the upper side of the substrate 20).

The PNLC panel 110 comprises a substrate 130 instead of the substrate 30 comprised by the PNLC 10. The substrate 130 is an active matrix substrate.

Similar to the substrate 30, the substrate 130 is configured so that a plurality of TFTs 32 and pixel electrodes 33 are provided on the transparent substrate 31. In addition, a plurality of wirings such as a source wiring 34, a gate wiring 35, a Cs wiring 36 (capacity supplementing wiring), and the like, are provided on the transparent substrate 31. Moreover, the substrate 130 is configured so that an inter-layer insulating film 134 is provided at an upper layer of the pixel electrode 33. Further, a reflecting part 133 is provided at an upper layer of the inter-layer insulating film 134.

The inter-layer insulating film 134 covers each of the wirings formed on the transparent substrate 31. Thus, the inter-layer insulating film 134 is formed on the entire surface of the transparent substrate 31. There is no particular restriction on the materials that the inter-layer insulating film 134 is manufactured from. Neither is there any particular restriction on the method with which the inter-layer insulating film 134 is manufactured. It is possible to use ingredients and methods that are normally used to manufacture an active matrix substrate of a liquid display panel.

The reflecting part 133 is placed inside the PNLC panel 110. The reflecting part 133 is placed at the back side of the PNLC panel 110 with respect to the PNLC layer 40. The reflecting part 133 acts as a reflecting plate that reflects light (image) projected from the projector 3. At the same time, the reflecting part 133 acts as a pixel electrode.

The reflecting part 133 is formed at the upper layer of the inter-layer insulating film 134. The reflecting part 133 is formed in the region at which the pixel electrodes 33 are formed (the same region that the pixel electrodes 33 are formed), when the substrate 130 is seen from a planar view. The reflecting part 133 is connected to the pixel electrode 33 via a contact hole 135 formed on the inter-layer insulating film 134.

The reflecting part 133 can be made of metallic material having a high conductivity and a high reflectance.

The reflecting part 133 may be formed by, for example, performing a patterning of aluminum, silver, and the like on the upper layer of the inter-layer insulating film 134 using a sputtering method or a vapor-deposition method. The contact hole 135 is formed on the inter-layer insulating film 135.

The front surface of the reflecting part 133 (the surface opposite to the side at which a contact with the inter-layer insulating film 134 is made) is the reflection surface 133a. The reflection surface 133a of the reflecting part 133 is a flat, mirror surface.

The PNLC panel 110 is configured so that the PNLC layer 40 is sandwiched by the reflecting part 133 and the opposing electrode 23. The reflecting part 133 is formed on the substrate 130. The opposing electrode 23 is formed on the substrate 20. The PNLC layer 40 is configured so that a light-transmitting region and a light-scattering region are formed selectively by an electric field generated by the electric voltage applied to the reflecting part 133 and the opposing electrode 23.

The reflecting part 133 is configured so that the reflection surface 133a is a flat plane. This configuration prevents the electric field applied to the liquid crystal of the PNLC layer 40 from becoming uneven.

As described above, the reflecting part 133 is placed at the back side of the PNLC layer 40 inside the PNLC panel 110. Therefore, the light projected from the projector 3 passes through the substrate 20 and the PNLC layer 40, and then reflects at the reflection surface 133a of the reflecting part 133. The reflected light then passes through the PNLC layer 40 and the substrate 20 once again. Then, this light exits the PNLC layer 40. Accordingly, among the transparent substrates 21 and 31 comprised by the PNLC panel 110, light does not pass through the transparent substrate 31.

Since the PNLC panel 110 is configured in this way, the reflectance is greater compared to the configuration in which the reflecting part is placed at the back side of the display panel. Hence, the distinct display, made as if a monochrome or multi-colored light (image) is looming out from a mirror, can be presented more vividly.

Incidentally, in the example pertaining to the present embodiment, the PNLC panel 110 is configured so that the substrate 20 is placed at the side where the viewer is located, and the substrate 30 is placed at the back side. The present embodiment is not restricted to this example. The substrate 30 may be placed at the side where the viewer is located, and the substrate 20 may be placed at the back side.

In this case, an inter-layer insulating film is placed above the opposing electrode 23 of the substrate 20 of the PNLC panel 10 shown in FIG. 5. Further, on top of this inter-layer insulating film, a film of metallic material is provided. This metallic material is conductive and has a high reflectance, similar to the reflecting part 133. In this way, a reflecting part is provided on the substrate 20.

The substrate 20 is placed opposite to the substrate 30 via the PNLC layer 40. The reflecting part is formed on the substrate 20. In this way, the PNLC panel 10 may be configured so that a reflecting part is placed inside the PNLC panel 10.

The present invention is not limited to the embodiments described above. Various alterations can be made within the scope of the claims. Any configuration obtained by combining a feature described in one embodiment with another feature described on another embodiment is also within the scope of the present invention.

As described above, a display system according to an aspect of the present invention comprises a reflection-type display device. The display system comprises a display device comprising a display panel and a reflecting part. The display panel does not comprise a coloring layer. In addition, the display panel selectively forms a light-transmitting region and a light-scattering region. The reflecting part is provided at a back surface side of the display panel. The display system also comprises a light source device projecting a monochrome light or a multicolor light to the display panel from a front surface side of the display panel.

According to the configuration described above, the display panel does not comprise a coloring layer. Thus, no light is absorbed by any coloring layer. Therefore, a projected image can be displayed vividly.

Furthermore, a monochrome or multicolor light is projected by the light source device onto the display panel from the front side. This monochrome or multicolor light passes through the display panel and is reflected by the reflecting part placed at the back side of the display panel. The monochrome or multicolor light then exits the display panel from the front side. As a result, the monochrome or multicolor light (image) at a light-scattering region, selectively formed on the display panel, can present a display in a distinct manner as if an image is looming out of a mirror.

As described above, a display system according to another aspect of the present invention comprises a reflection-type display device. The display system comprises a display device comprising a display panel and a reflecting part. The display panel does not comprise a coloring layer. The display panel selectively forms a light-transmitting region and a light-scattering region. The reflecting part is provided at an interior portion of the display panel. The display system also comprises a light source device projecting a monochrome light or a multicolor light to the display panel from a front surface side of the display panel.

According to the configuration described above, the display panel does not comprise a coloring layer. Thus, no light is absorbed by any coloring layer. Therefore, a projected image can be displayed vividly.

Furthermore, a monochrome or multicolor light is projected by the light source device onto the display panel from the front side. This monochrome or multicolor light passes through the display panel and is reflected by the reflecting part placed inside the display panel. The monochrome or multicolor light then exits the display panel from the front side. As a result, the monochrome or multicolor light (image) at a light-scattering region, selectively formed on the display panel, can present a display in an incomparable manner as if an image is looming out of a mirror.

Moreover, the monochrome or multicolor light is projected by the light source device onto the display panel from the front side. This monochrome or multicolor light is reflected by the reflecting part placed inside the display panel. The monochrome or multicolor light then exits the display panel from the front side. As a result, the reflectance can be enhanced compared to the case in which the reflecting part is placed at the back side of the display panel. Hence, the monochrome or multicolor light (image) can present a display in a distinct manner as if an image is looming out of a mirror.

Incidentally, the display system may be configured so that the reflecting part comprises a reflection surface reflecting a light from the light source device. The reflection surface may be a flat mirror surface. As a result, light can be reflected at a high reflectance.

Incidentally, the display system may be configured so that the reflecting part comprises a reflection surface reflecting a light from the light source device. The reflection surface may be configured to perform a recursive reflection. This configuration provides a remedial measure to the problem that, when the direction of the regular reflection is too bright and a mirror is used, the contrast in the display sent from the light source device tends to diminish.

Incidentally, the display system may be configured so that a corner cube array is provided on the reflection surface. As a result, the reflection surface may be configured to perform a recursive reflection.

Incidentally, the display system may be configured so that it further comprises a reflecting member reflecting a light outputted by the light source device. The reflecting member projects the light to the display panel. Here, the light source device and the reflecting part are positioned so that a direction of an optical axis of the light outputted by the light source device is parallel to a planar direction of the reflecting part. In addition, the reflecting part comprising a reflection surface comprises an irregular form. This irregular form comprises a plurality of slopes reflecting the light outputted by the light source device. The plurality of slopes of the irregular form are provided so that an angle, with respect to a flat plane parallel to the optical axis, gradually becomes smaller from an end part, at a side close to the light source device, towards an end part at a side far from the light source device.

As a result, the light source device and the reflecting part are positioned so that a direction of an optical axis of the light outputted by the light source device is parallel to a planar direction of the reflecting part. Therefore, the light source device and the display panel may be placed without occupying too much space.

In addition, the plurality of slopes of the irregular form of the reflection surface are provided so that an angle, with respect to a flat plane parallel to the optical axis, gradually becomes smaller from an end part, at a side close to the light source device, towards an end part at a side far from the light source device. As a result, the light outputted from the light source device can be reflected by the reflecting part toward the frontal direction.

Incidentally, the display system may be configured so that the reflecting part comprises a material comprising an aluminum or a silver as a primary constituent. As a result, the reflection surface can be configured to have a high reflectance.

Incidentally, the display system may be configured so that the display panel comprises an active substrate, an opposing substrate placed opposite to the active substrate, and a display medium provided between the active substrate and the opposing substrate. Here, a plurality of switching elements are provided in matrix form on the active substrate. Moreover, the display medium performs a switching between a light-transmitting state and a light-scattering state based on whether or not an electric field is applied. The light-transmitting region and the light-scattering region are selectively formed according to the plurality of switching elements controlling whether or not an electric field is applied to the display medium.

As a result of this configuration, it is possible to create a light-scattering region having any desired shape. Therefore, a high-definition display can be made at will.

Incidentally, the display system may be configured so that the light source device projects a light to the light-scattering region formed on the display panel.

The display is configured so that an image is displayed at the light-scattering region by the light projected from the light source device. Thus, light is projected from the light source device to the light-scattering region formed on the display panel, as described above. As a result, a crisp, high-definition display can be provided. The power consumption can be reduced as well.

Incidentally, the display system may be configured so that an angle, at which an incidence angle of a light projected from the light source device to the display panel becomes maximum, is less than or equal to a Brewster's angle.

Considering the polarization component (S polarization) in a direction perpendicular to the plane of incidence, the reflectance increases rapidly when the angle of incidence becomes greater than Brewster's angle. As a result, the amount of light that enters the display panel from the light source device decreases.

Therefore, according to the configuration described above, it is possible to prevent a decrease in the amount of light that enters the display panel from the light source device.

Incidentally, the display system may be configured so that the display medium is a liquid crystal of a polymer-dispersed type or a polymer-network type, comprising a polymer and a liquid crystal droplet. The liquid crystal droplet is independent or continuous. The liquid crystal becomes light-transmitting when an electric field is applied. The liquid crystal becomes light-scattering when an electric field is not applied. An orienting procedure is performed on a surface of the active substrate facing the display medium and on a surface of the opposing substrate facing the display medium. The liquid crystal droplet is aligned parallel to a substrate surface along a direction in which the orienting procedure is performed on the active substrate and the opposing substrate. The light source device is positioned so that, when a planar projection of a light projected from the light source device is made on the display panel, an incident direction of the light projected from the light source device entering the display panel is perpendicular to an alignment direction of the liquid crystal droplet.

When the display panel is in a light-scattering state, the intensity of scattered-light entering from the normal direction of the panel becomes acutely scattered in a direction perpendicular to the orienting direction of the liquid droplet seen from the normal direction of the panel.

Therefore, by placing the light source device as described above, the light from the light source device entering the display panel can be scattered more effectively before being sent to the viewer.

Incidentally, the display system may be configured so that the display medium is a liquid crystal of a polymer-dispersed type or a polymer-network type, comprising a polymer and a liquid crystal droplet. The liquid crystal droplet is independent or continuous. The liquid crystal becomes light-scattering when an electric field is applied. The liquid crystal becomes light-transmitting when an electric field is not applied. An orienting procedure is performed on a surface of the active substrate facing the display medium and on a surface of the opposing substrate facing the display medium. A long axis of a liquid crystal molecule of the liquid crystal droplet is aligned parallel to a substrate surface along a direction in which the orienting procedure is performed on the active substrate and the opposing substrate. The light source device is positioned so that, when a planar projection of a light projected from the light source device is made on the display panel, an incident direction of the light projected from the light source device entering the display panel is perpendicular to the long axis of the liquid crystal molecule.

When the display panel is in a light-scattering state, the intensity of scattered-light entering from the normal direction of the panel becomes acutely scattered in a direction perpendicular to the long axis of the liquid crystal molecule seen from the normal direction of the panel.

Therefore, by placing the light source device as described above, the light from the light source device entering the display panel can be scattered more effectively before being sent to the viewer.

Incidentally, the display system may be configured so that a light is projected from the light source device to the display panel only when a colored presentation is displayed. Thus, a light is not projected from the light source device when an uncolored presentation is displayed. A display is performed by selectively applying an electric field to the display medium and selectively creating a light-scattering state and a light-transmitting state.

According to this configuration, an aesthetic display can be shown when a colored presentation is displayed. Meanwhile, when text and the like are displayed, and it is not necessary to display a colored presentation, only the display panel may be driven to perform an uncolored light-scattering/light-transmitting display. By turning off the output of the light source device, power consumption can be reduced.

Incidentally, the display system may be configured so that a plurality of the light source devices are provided. Here, a color of a light projected from each one of the plurality of the light source devices is different from one another.

As a result, a colorful, rich display can be displayed on the display panel by showing different colors in each region to which each one of the light source devices projects light. At the same time, a display having another, different color may be shown by blending the light projected from each one of the light source devices.

Incidentally, an electronic device according to the present invention may comprise the display system according to the present invention. Examples of such an electronic device include electronic devices that can be used as portable terminals such as portable telephones, electronic dictionaries, and electronic photo frames. Other examples include digital signage, theater systems, displays used in offices, TV (television) conferencing systems, and the like.

Incidentally, a portable terminal according to the present invention may comprise the display system described above.

Incidentally, the portable terminal may be configured so that the display device of the display system is provided as an independent device. Further, the light source device of the display system is provided as another independent device separate from the display device.

According to this configuration, the display device of the display system is provided as an independent device, and the light source device of the display system is provided as another, separate independent device. As a result, the weight of each device within the portable terminal may be spread out. In addition, the light source device may be placed far away from the display panel of the display device. Therefore, without using an intricate optical system, the light source device can radiate light to the display panel evenly throughout the entire surface of the display area of the display panel.

### INDUSTRIAL APPLICABILITY

A display system according to the present invention is configured so that light is reflected at the reflecting part. In this way, the image on the light-scattering region can be displayed as if it is floating in mid-air inside a mirror. As a result, the display system according to the present invention can be applied in a favorable manner to various electronic devices such as portable telephones, portable terminals such as electronic dictionaries, electronic photo frames, digital signage, theater systems, displays used in offices, TV conferencing systems, and the like.

### LIST OF REFERENCE NUMERALS AND SIGNS

1 display system
2 display device
3 projector (light source device)
4 light source device
10 PNLC panel (display panel)
12 transparent part (light-transmitting region)
13 scattering part (light-scattering region)
14 reflecting part
14a, 14b reflection surface
20 substrate (opposing substrate)
30, 130 substrate (active substrate)
32 TFT (switching element)
40 PNLC layer (display medium, liquid crystal)
41 liquid crystal droplet
80 electronic dictionary
90 portable telephone
95 small projector
110 PNLC panel (display panel)
133 reflecting part
133a reflection surface
θb Brewster's Angle

1. A display system comprising a reflection-type display device, the display system comprising:
a display device comprising a display panel and a reflecting part, wherein the display panel does not comprise a coloring layer, the display panel selectively forms a light-transmitting region and a light-scattering region, and the reflecting part is provided at a back surface side of the display panel; and
a light source device projecting a monochrome light or a multicolor light to the display panel from a front surface side of the display panel.

2. A display system comprising a reflection-type display device, the display system comprising:
a display device comprising a display panel and a reflecting part, wherein the display panel does not comprise a coloring layer, the display panel selectively forms a light-transmitting region and a light-scattering region, and the reflecting part is provided at an interior portion of the display panel; and
a light source device projecting a monochrome light or a multicolor light to the display panel from a front surface side of the display panel.

3. The display system according to claim 1, wherein:
the reflecting part comprises a reflection surface reflecting a light from the light source device; and
the reflection surface is a flat mirror surface.

4. The display system according to claim 1, wherein:
the reflecting part comprises a reflection surface reflecting a light from the light source device; and
the reflection surface performs a recursive reflection.

5. The display system according to claim 3, wherein a corner cube array is provided on the reflection surface.

6. The display system according to claim 1 further comprising a reflecting member reflecting a light outputted by the light source device, the reflecting member projecting the light to the display panel, wherein:
the light source device and the reflecting part are positioned so that a direction of an optical axis of the light outputted by the light source device is parallel to a planar direction of the reflecting part;
the reflecting part comprising a reflection surface comprising an irregular form, the irregular form comprising a plurality of slopes reflecting the light outputted by the light source device; and
the plurality of slopes of the irregular form are provided so that an angle, with respect to a flat plane parallel to the optical axis, gradually becomes smaller from an end part, at a side close to the light source device, towards an end part at a side far from the light source device.

7. The display system according to claim 1, wherein the reflecting part comprises a material comprising an aluminum or a silver as a primary constituent.

8. The display system according to claim 1, wherein:
the display panel comprises an active substrate, an opposing substrate placed opposite to the active substrate, and a display medium provided between the active substrate and the opposing substrate, wherein a plurality of switching elements are provided in matrix form on the active substrate, and wherein the display medium performs a switching between a light-transmitting state and a light-scattering state based on whether or not an electric field is applied; and
the light-transmitting region and the light-scattering region are selectively formed according to the plurality of switching elements controlling whether or not an electric field is applied to the display medium.

9. The display system according to claim 1, wherein the light source device projects a light to the light-scattering region formed on the display panel.

10. The display system according to claim 9, wherein an angle, at which an incidence angle of a light projected from the light source device to the display panel becomes maximum, is less than or equal to a Brewster's angle.

11. The display system according to claim 8, wherein:
the display medium is a liquid crystal of a polymer-dispersed type or a polymer-network type, comprising a polymer and a liquid crystal droplet, the liquid crystal droplet being independent or continuous, the liquid crystal becoming light-transmitting when an electric field is applied, the liquid crystal becoming light-scattering when an electric field is not applied;
an orienting procedure is performed on a surface of the active substrate facing the display medium and on a surface of the opposing substrate facing the display medium;
the liquid crystal droplet is aligned parallel to a substrate surface along a direction in which the orienting procedure is performed on the active substrate and the opposing substrate;
the light source device is positioned so that, when a planar projection of a light projected from the light source device is made on the display panel, an incident direction of the light projected from the light source device entering the display panel is perpendicular to an alignment direction of the liquid crystal droplet.

12. The display system according to claim 8, wherein:
the display medium is a liquid crystal of a polymer-dispersed type or a polymer-network type, comprising a polymer and a liquid crystal droplet, the liquid crystal droplet being independent or continuous, the liquid crystal becoming light-scattering when an electric field is applied, the liquid crystal becoming light-transmitting when an electric field is not applied;
an orienting procedure is performed on a surface of the active substrate facing the display medium and on a surface of the opposing substrate facing the display medium;
a long axis of a liquid crystal molecule of the liquid crystal droplet is aligned parallel to a substrate surface along a direction in which the orienting procedure is performed on the active substrate and the opposing substrate;
the light source device is positioned so that, when a planar projection of a light projected from the light source device is made on the display panel, an incident direction of the light projected from the light source device entering the display panel is perpendicular to the long axis of the liquid crystal molecule.

13. The display system according to claim 8, wherein:
a light is projected from the light source device to the display panel only when a colored presentation is displayed;
a light is not projected from the light source device when an uncolored presentation is displayed; and
a display is performed by selectively applying an electric field to the display medium and selectively creating a light-scattering state and a light-transmitting state.

14. The display system according to claim 1, wherein:
a plurality of the light source devices is provided; and
a color of a light projected from each one of the plurality of the light source devices is different from one another.

15. A portable terminal comprising the display system according to claim 1.

16. The portable terminal according to claim 15, wherein:
the display device of the display system is provided as an independent device; and
the light source device of the display system is provided as an another independent device separate from the display device.

17. An electronic device comprising the display system according to claim 1.
